(19) United States
(12) Patent Application Publication
(10) Pub. No.: US 2014/0137323 A1
(43) Pub. Date: May 22, 2014

(54) PATIENT LIFT AND POSITIONING SYSTEM, AND ADJUSTABLE COMPONENTS THEREOF

(71) Applicant: UNIVERSITY HEALTH NETWORK, Toronto (CA)

(72) Inventors: Geoffrey Roy FERNIE,, Etobicoke (CA); Adam Mathew SOBCHAK, Toronto (CA); Thomas Daniel SMYTH, Aurora (CA); Cesar Marquez CHIN, Toronto (CA); Tilak DUTTA, Toronto (CA)

(73) Assignee: UNIVERSITY HEALTH NETWORK, Toronto (CA)

(21) Appl. No.: 14/084,747

(22) Filed: Nov. 20, 2013

Related U.S. Application Data
(60) Provisional application No. 61/728,689, filed on Nov. 20, 2012.

(51) Int. Cl. A61G 7/10

(52) U.S. Cl. CPC A61G 7/1049
USPC 5/83.1

(57) ABSTRACT

Described are various embodiments of a patient lift and positioning system, and adjustable components thereof. In one embodiment, a patient positioning interface is suspended from a patient support mechanism and used in positioning a thus supported patient in two or more positions. The interface comprises a legrest portion for supporting a lower body portion of the patient and a backrest portion pivotally coupled to the legrest portion for supporting an upper body portion of the patient. The interface further comprises a powered drive mechanism independently acting on each of the legrest portion and the backrest portion to independently adjust relative to one another a legrest and backrest angle of the legrest portion and backrest portion, respectively.

### CROSS REFERENCE TO RELATED APPLICATIONS

This application claims the benefit of priority from U.S. Provisional Application No. 61/728,689 filed Nov. 20, 2012, the entire contents of which are hereby incorporated herein by reference.

### FIELD OF THE DISCLOSURE

The present disclosure relates to heath care equipment, and in particular, to a patient lift and positioning system, and adjustable components thereof.

### BACKGROUND

Lifting, repositioning and/or transferring patients, for example in a healthcare or long term care facility, can be particularly challenging and at times strenuous for individuals attending to such patients. For example, the repositioning, transport or transfer of patients with limited or restricted mobility can pose significant challenges, particularly when attempted with limited resources, such as with limited staff in a medical, long term care or rehabilitation facility, or again with limited or inadequate equipment.

There remains a need for a new patient lift and positioning system, and adjustable components thereof, that overcome some of the drawbacks of known techniques, or at least, provides the public with a useful alternative.

This background information is provided to reveal information believed by the applicant to be of possible relevance. No admission is necessarily intended, nor should be construed, that any of the preceding information constitutes prior art.

### SUMMARY

Some aspects of this disclosure provide a patient lift and positioning system. Further aspects of this disclosure provide adjustable components of a patient lift and positioning system.

In accordance with one embodiment, there is provided a patient positioning interface to be suspended from a patient support mechanism and used in positioning a thus supported patient in two or more positions. The interface comprises a legrest portion for supporting a lower body portion of the patient and a backrest portion pivotally coupled to the legrest portion for supporting an upper body portion of the patient. The interface further comprises a powered drive mechanism independently acting on each of the legrest portion and the backrest portion to independently adjust relative to one another a legrest and backrest angle of the legrest portion and backrest portion, respectively.

In accordance with another aspect, there is provided a patient lift and positioning system comprising a mobile patient support unit having a base unit; a height adjustable mast extending upwardly from the base unit; and a length adjustable boom extending outwardly from an upper section of the mast. The system further comprises a patient positioning interface operatively suspended from the boom thereby allowing for vertical and horizontal adjustment thereof relative to the base unit. The interface comprises: a legrest portion for supporting a lower body portion of the patient; a backrest portion pivotally coupled to the legrest portion for supporting an upper body portion of the patient; and a powered drive mechanism independently acting on each of the legrest portion and the backrest portion to independently adjust relative to one another a legrest and backrest angle of the legrest portion and backrest portion, respectively, to position the patient in two or more positions.

In accordance with another embodiment, there is provided a patient lift and positioning system comprising a mobile patient support unit and a patient positioning interface suspended from the patient support unit. The patient positioning interface comprises a legrest portion for supporting a lower body portion of the patient; a backrest portion pivotally coupled to the legrest portion for supporting an upper body portion of the patient; and a powered drive mechanism independently acting on each of the legrest portion and the backrest portion to adjust a relative angular positioning therebetween and thus allow positioning of the patient in a seated position. At least one of the backrest portion and the legrest portion comprises a powered lengthwise adjustable support member by which the patient is at least partially supported, wherein lengthwise adjustment of the powered adjustable support member serves to adjust patient posture in the seated position.

In accordance with another embodiment, there is provided a control device for a patient positioning interface to be suspended from a patient support mechanism and used in positioning a thus supported patient in two or more positions. The control module comprises a tactile user interface responsive to a least one linear user action and at least one rotational user action to output a corresponding control signal as a function thereof, wherein the tactile user interface is integral to the patient positioning interface and thus in close proximity to the patient. The device further comprises a powered control platform communicatively linked to the user interface to receive as input the control signal and output a corresponding drive signal to drive a corresponding actuation of the patient positioning interface that is spatially recognizable from the at least one linear user action and the at least one rotational user action. The tactile user interface thus provides an intuitive control interface to the patient positioning interface in positioning the patient between the two or more positions.

In one such embodiment, the linear user action drives a linear motion of a selected component of the patient positioning interface, and the rotational user action drives a rotational or angular motion of a same or other selected component of the patient positioning interface.

In another such embodiment, the control device further comprises a mode selector operable to switch between operational modes such that a same linear user action or a same rotational user action imparts distinct motions to mode selected components of the patient positioning interface when operated in distinct modes.

In yet another such embodiment, the tactile user interface comprises one of a moveable structural interface responsive to a user physical movement thereof, and a touch-operable interface responsive to a user touch movement thereon.

Other aims, objects, advantages and features will become more apparent upon reading of the following non-restrictive description of specific embodiments thereof, given by way of example only with reference to the accompanying drawings.

### BRIEF DESCRIPTION OF THE FIGURES

Several embodiments of the present disclosure will be provided, by way of examples only, with reference to the appended drawings, wherein:

FIG. 1 is a perspective view of a patient lift and positioning system, in accordance with one embodiment of the invention, in a fully extended and patient lie-flat position;

FIG. 2 is a perspective view of the patient lift and positioning system of FIG. 1, in a fully retracted and patient seated-slouched position;

FIG. 3 is a perspective view of the patient lift and positioning system of FIG. 1, in a fully extended and rotated patient transport position, with base feet thereof in a splayed position;

FIG. 4 is a bottom plan view of the patient lift and positioning system of FIG. 1, showing a system displacement mechanism thereof;

FIG. 5 is a rear perspective view of a base control module of the patient lift and positioning system of FIG. 1;

FIG. 6 is a side view of a patient positioning interface of the patient lift and positioning system of FIG. 1, shown in a patient seated-slouched position and identifying a positioning interface control module thereof;

FIG. 7 is a side view of the patient positioning interface of FIG. 6, showing operation of the positioning interface control module thereof to reposition the interface from the patient seated-slouched position to a patient lie-flat position;

FIG. 8 is a side view of the patient positioning interface of FIG. 7, showing operation of the positioning interface control module thereof to reposition the interface from the patient lie-flat position to a patient transport position;

FIG. 9 is a side view of the patient positioning interface of FIG. 6, showing operation of the positioning interface control module thereof to reposition the interface from the patient seated-slouched position to a patient seated-aligned position;

FIG. 10 is a perspective view of a three-part telescoping mast of the patient lift and positioning system of FIG. 1;

FIG. 11 is a side view of a cascading lead screw comprising an inner lead screw, a middle lead screw and an outer lead screw operatively mounted within the telescoping mast of FIG. 10 and operable to extend and retract the mast, in accordance with one embodiment of the invention;

FIG. 12 is a perspective cross-sectional view of the cascading lead screw of FIG. 11 in a fully retracted position;

FIG. 13 is a perspective cross-sectional view of the cascading lead screw of FIG. 12 while extending from the fully retracted position, in which the inner lead screw is initially extended from within the middle lead screw upon rotation of the outer lead screw;

FIG. 14 is a perspective cross-sectional view of the cascading lead screw of FIG. 13 in which the inner lead screw is fully extended and thus locked with the middle lead screw, the latter further extended from within the outer lead screw upon further rotation of the outer lead screw;

FIG. 15 is a perspective cross-sectional view of the cascading lead screw of FIG. 14 in a fully extended position;

FIG. 16 is a close-up perspective cross-sectional view of a middle and outer lead screw interface, in accordance with one embodiment;

FIG. 17 is a perspective view of the mast of FIG. 10 in which a base section thereof is shown as partially sectioned to illustrate a relative sliding engagement thereof with a middle section of the mast, in accordance with one embodiment;

FIG. 18 is a perspective view of a three-part telescoping boom of the patient lift and positioning system of FIG. 1, in which a base section thereof is shown as partially sectioned to illustrate a relative sliding engagement thereof with a middle section of the boom and further to illustrate a drive mechanism therefor, in accordance with one embodiment;

FIG. 19 is a perspective cross-sectional view of a neck interface between the boom of FIG. 18 and the patient positioning interface of FIG. 6, in accordance with one embodiment;

FIG. 20 is a perspective cross-sectional view from below of the neck interface of FIG. 19, further showing a drive mechanism for rotating the head of the patient positioning interface;

FIG. 21 is a perspective view from below of an upper portion of the patient positioning interface of FIG. 20, further showing a rotating neck drive mechanism thereof;

FIG. 22 is a perspective view from above of a lower portion of the patient positioning interface of FIG. 6, showing leg and back drive mechanisms for driving respective pairs of quadrant arms thereof in angling a leg and a back portion of the positioning interface, in accordance with one embodiment;

FIG. 23 is a perspective view from above of the lower portion of the patient positioning interface of FIG. 22, further showing a curved rack section for one of the quadrant arms to be driven by a corresponding sprocket, in accordance with one embodiment;

FIG. 24 is a perspective view of the lower portion of the patient positioning interface of FIG. 22, with a side wall thereof removed to show an internal guiding mechanism for engaging one of the quadrant arms and guiding travel of same when driven;

FIG. 25 is a side view of the patient positioning interface of FIG. 6, showing an internal seat alignment mechanism thereof;

FIG. 26 is a perspective view of the internal seat alignment mechanism of FIG. 25;

FIG. 27 is a rear perspective view of the internal seat alignment mechanism of FIG. 25; and

FIGS. 28 to 35 are sequential perspective views of the patient lift and positioning system of FIG. 1, in which a patient is illustratively lifted from a bed in a lie-flat position, and ultimately positioned and descended into a wheelchair.

### DETAILED DESCRIPTION

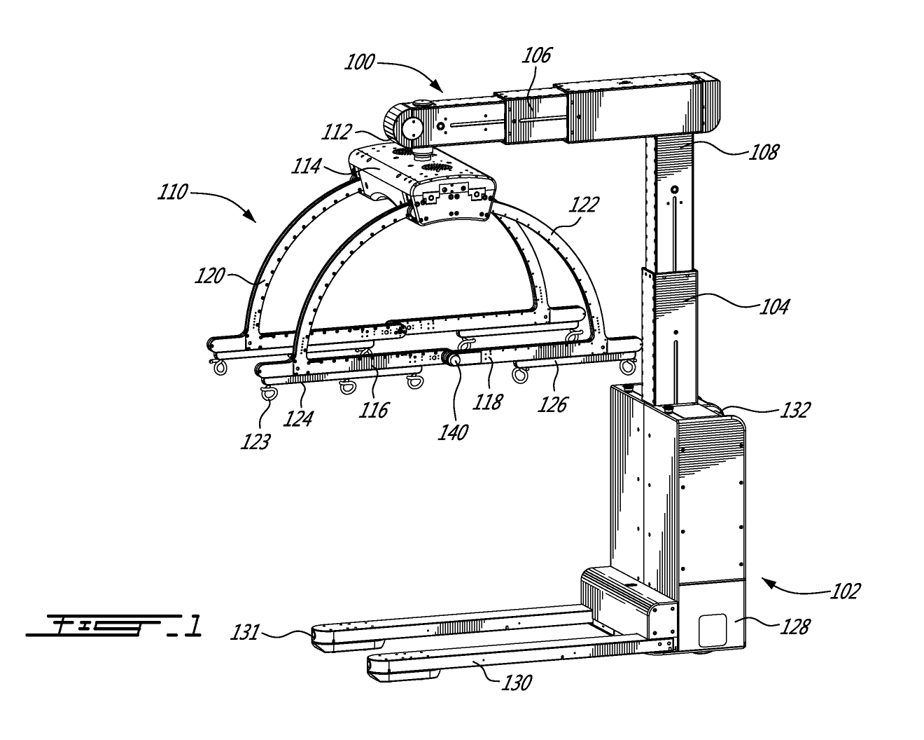

With reference to FIG. 1, and in accordance with one embodiment, a patient lift system, generally referred to using the numeral 100, will now be described. The lift system 100 generally comprises a mobile base unit 102, a telescoping mast 104 extending vertically from the base unit 102, a telescoping boom 106 operatively coupled at an upper extremity 108 of the mast 104 and configured to extend horizontally therefrom, and a patient positioning interface (PPI) 110 operatively coupled at a free hanging extremity 112 of the boom 106.

The patient positioning interface 110 generally comprises a head portion 114 rotationally coupled at the free hanging extremity 112 of the boom 106. The PPI head 114 is generally configured to house respective drive mechanisms for independently actuating a legrest portion 116 and a backrest portion 118 of the PPI 110, which portions are pivotally coupled to one another in allowing for multiple patient positioning configurations, such as for example, but not limited to supine, seated (slouched), seated (upright), and transport positions, to be discussed below. In particular, each of the legrest 116 and backrest 118 portions are positionally associated with a respective set of arcuate rails 120, 122, each configured, in this example, to travel continuously along arcuate paths respectively defined thereby upon actuation of the legrest and backrest positioning mechanisms housed within the PPI head 114. Accordingly, each of the legrest and backrest portions effectively defines quadrant arms in a gimbal-like configuration. As will be described in greater detail below, the provision of this mechanical architecture provides for a precisely controllable patient positioning interface that can be used to controllably angularly retract and deploy both the backrest portion and legrest portion (e.g. powered ascent and descent of support members), independently, over a substantially continuous range of angular positions, and without reliance on gravity, for example as would otherwise be required in a pulley or strap system.

In this particular embodiment, a series of spiral hooks 123, or other such fastening or coupling means, are provided on each of the legrest and backrest portions so to facilitate coupling of patient lift/support straps, harnesses and/or slings thereto, namely to extend between parallel leg and back support members 124, 126 thereof. It will be appreciated that different types and numbers of lift/support straps or the like may be utilised depending on the intended use and purpose of the system 100, and that, without departing from the general scope and nature of the present disclosure. For instance, where a number of straps are used to lift a patient in a lie-flat position, one or more of these straps may be removed upon positioning the patient in a seated position, for instance in allowing the patient's calves to be released and hang more comfortably from the PPI 110.

To further enhance positioning adjustability, the parallel leg and back support members 124, 126 are further longitudinally adjustable thus allowing for a lengthwise displacement of the support members 124, 126 relative to their respective leg and back support portions 116, 118. This feature, as will be illustratively described in greater detail below, may allow for greater precision in positioning a patient for, during and after transport, which may not only allow for greater patient comfort, but also allow for a reduction in effort generally required by a caregiver in refining a patient's posture before, during or after transport. For example, as will be shown below, the PPI 110 may be configure to transport a patient comfortably and safely in a patient-seated slouched position, and then be actuated to redress the patient's seated posture (e.g. upon retracting the legrest support member 124 and/or deploying the backrest support member 126) for alignment with a wheelchair in which the patient is to be rested in an upright seated position. Otherwise, a caregiver may be required to adjust the patient's posture once released, or again tilt the wheelchair to match the transport position of the patient, which can be difficult if not impossible to achieve where the chair and/or patient are particularly heavy.

Given the continuously adjustable nature of the PPI 110, other advantageous transport positions may be achieved, such as a fully supine position (e.g. to mitigate pain, breathing difficulties and/or to facilitate fracture care, or again to transport cadavers), or a reclined supine position (e.g. with the head partially raised, a position particularly appropriate for cardiac patients). Other exemplary postures benefitting from continuously and independently adjustable legrest and headrest portions may include positions particular to a given imaging equipment or the like. Other such examples will become readily apparent to the person of ordinary skill in the art upon reference to the following details and examples.

In FIG. 1, the system 100 is shown in a fully extended position, namely where the mast 104 and boom 106 are in their respective fully extended positions. The patient positioning interface 110 is thus operatively disposed in an elevated and laterally extended position above the base 102, in this case with the legrest and backrest portions 116, 118 each oriented in a fully deployed position so to position a patient in a supine position.

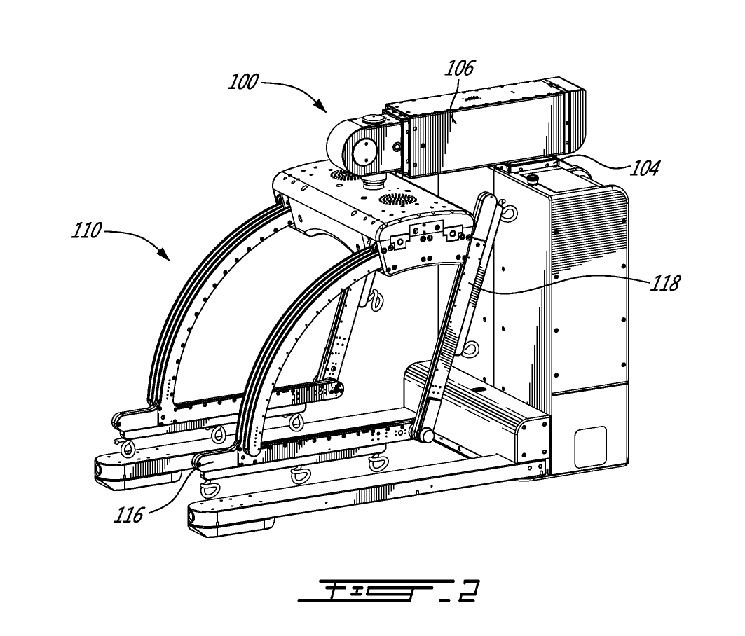

In FIG. 2, the system 100 is now shown in a fully retracted position, namely where the mast 104 and boom 106 are in their respective fully retracted positions. The patient positioning interface 110 is thus operatively disposed in a lowered and laterally contracted position above the base 102, in this case with the legrest portion 116 in full angular deployment and the backrest portion 118 in full angular retraction, to thereby position a patient in a lowered seated position.

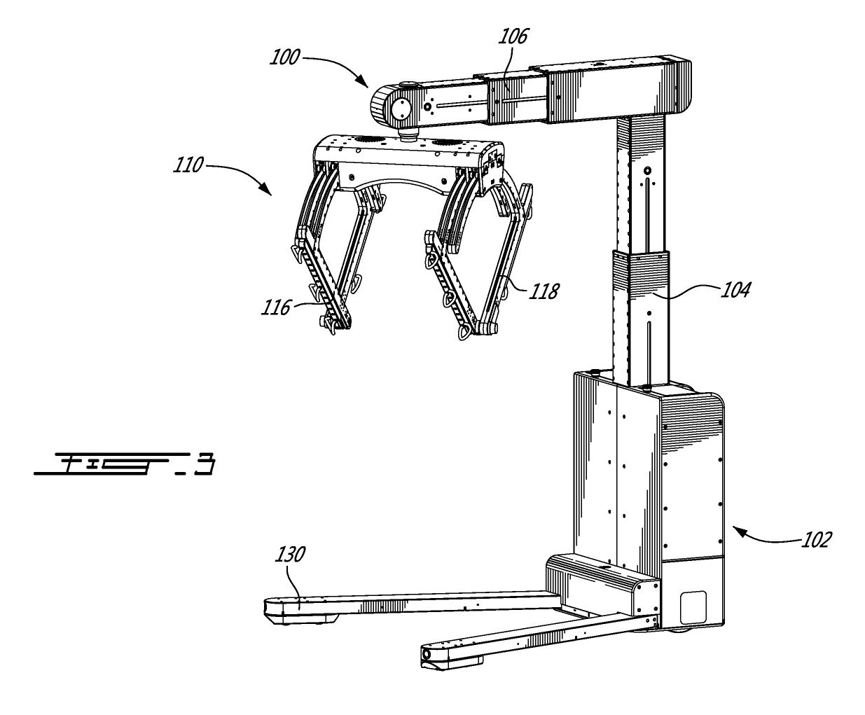

In FIG. 3, the system 100 is again shown in a fully extended position, this time with the patient positioning interface 110 in a rotated transport position, namely in which the legrest and backrest portions 116, 118 are each angularly oriented in a partially deployed position so to position a patient in a transport (e.g. hanging V-shaped) position. The wheeled counterbalancing feet 130 (discussed below) of the base unit 102 are shown in a splayed orientation, which, in some situations, may allow for greater system manoeuvrability.

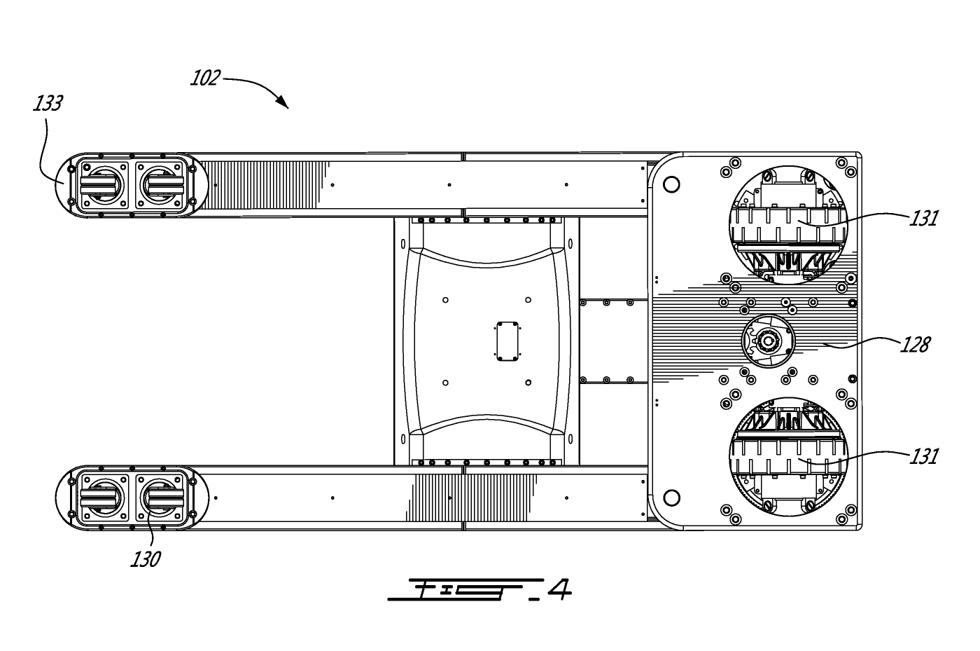

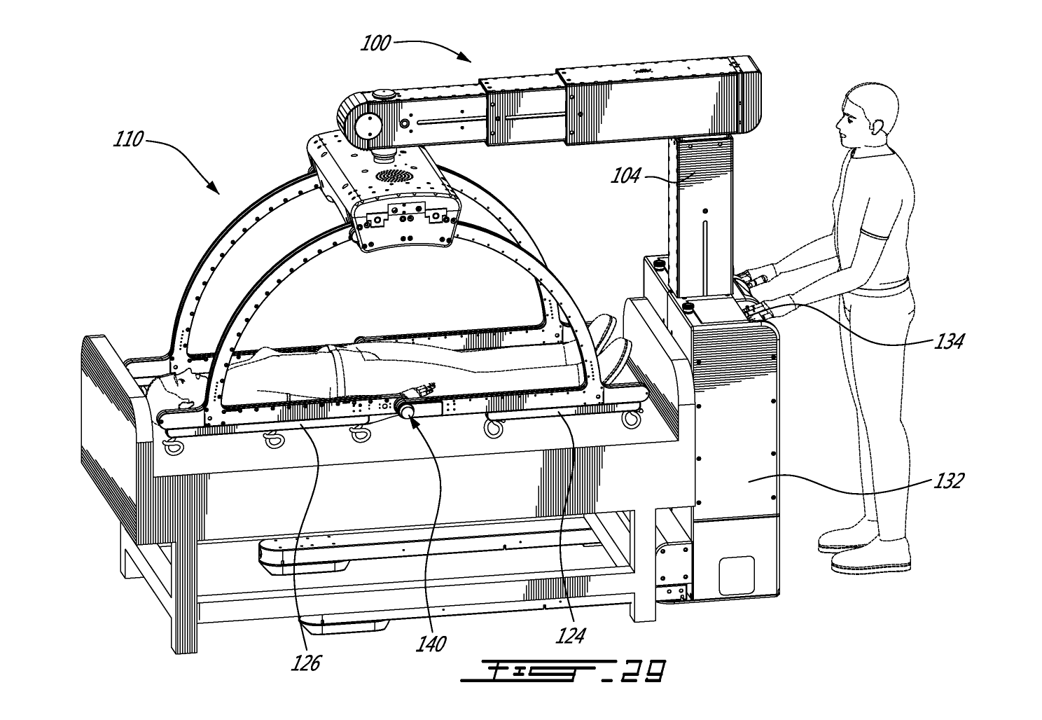

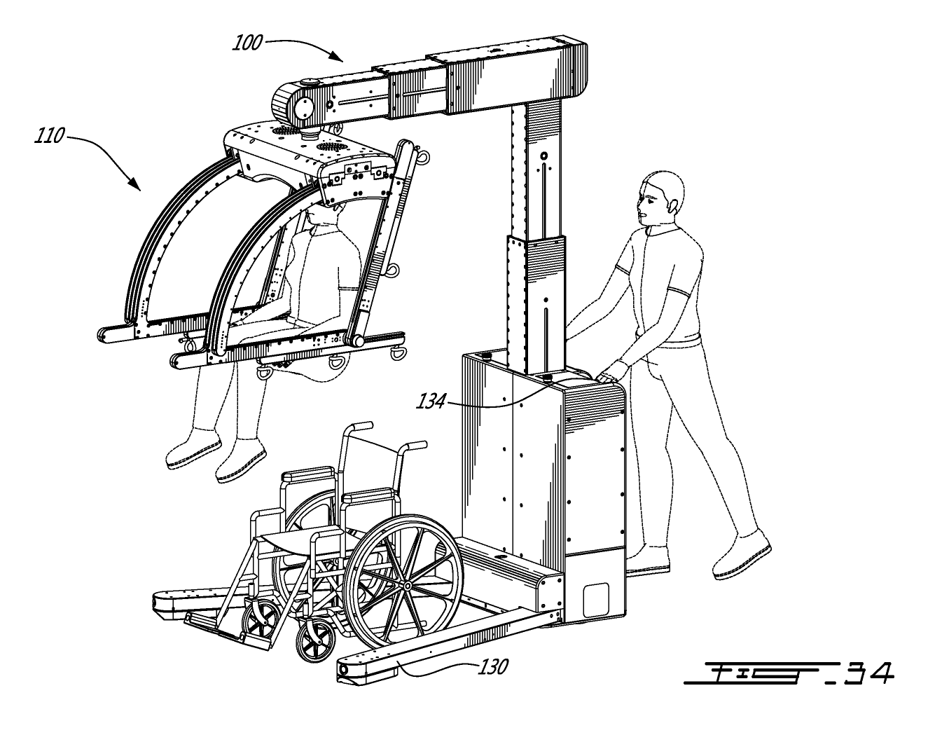

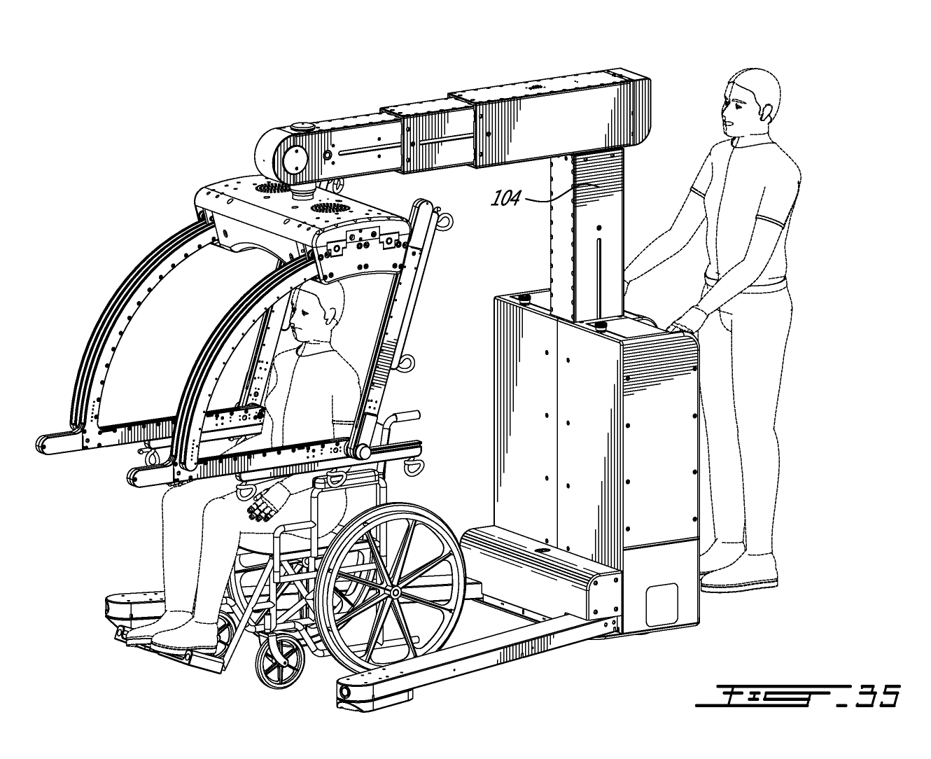

With reference to FIG. 4, the base unit 102 generally comprises a wheeled power-drive module 128 and wheeled counterbalancing feet 130 extending horizontally therefrom. In this particular embodiment, the base unit feet 130 are fitted with free-rotating casters or the like. The feet 130 are further configured to be selectively oriented in a parallel position (e.g. as shown) or in a splayed position (e.g. see FIG. 3) via actuation of a corresponding drive mechanism (not shown) housed within the base unit 102. For example, each foot or fork may in fact consist of an L-shaped structure, whereby a drive mechanism is configured to impart a drive force on the short leg of the L-shaped structure to thereby invoke a rotation of the feet 130 toward or away from the other. Upon implementing distinct foot-splaying drive mechanisms for each foot 130, splaying action may be imparted distinctly on each foot 130, or simultaneously. Accordingly, the system 100 may be configured to slide under a patient's bed when seeking to position the patient positioning interface 110 above a patient while lying in bed (e.g. see FIG. 29), and to splay as appropriate (e.g. see FIGS. 34, 35), for example upon approaching a wheelchair to which a patient is to be lowered in a seated position.

In this particular embodiment, and as will be described in greater detail below, the drive wheels 131 of the power-drive module 128 may be automatically reoriented via one or more controllers to facilitate displacement of the system 100. For example, the wheels 131 may be set in a forward position to move the system 100 forward and backward, a lateral position to move the system 100 left and right, and a rotation position whereby the wheels 131 are oriented at about 150 or 160 degrees from one another (e.g. 75 to 80 degrees in opposite directions from a forward direction), thereby allowing the system 100 to rotate around its vertical axis. As will be appreciated by the person skilled in the art, different angles may be selected based on a rotation dynamic of the system 100 desired, for example to adjust a center of rotation about which the system 100 rotates in rotation mode (e.g. around the center of the base unit 102, around a vertical axis defined by the neck portion of the PPI 110, etc.)

Further, collision avoidance sensors, such as for example, but not limited to, ultrasonic sensors 133 or the like, may be provided at respective foot extremities to warn an operator of an impending collision, for example. In one embodiment, the collision avoidance sensor may be configured to raise an alarm (or an increasingly persistent alarm) as the system 100 approaches a potential obstacle. The system 100 may further or alternatively be configured to stop moving upon an imminent collision being detected. In a similar fashion, collision avoidance sensors or sensor arrays may be disposed on the boom 106 (e.g. at the front and back to detect a potential obstacle when extending or raising the boom 106), as can contact pads be provided on the perimeter of the base unit 102 (e.g. around the drive module 128 and/or feet 130), on the boom 106 or mast 104, and/or at the tip of the feet 130 to detect an imminent or immediate collision and automatically power off the system 100 or a corresponding function thereof, for example.

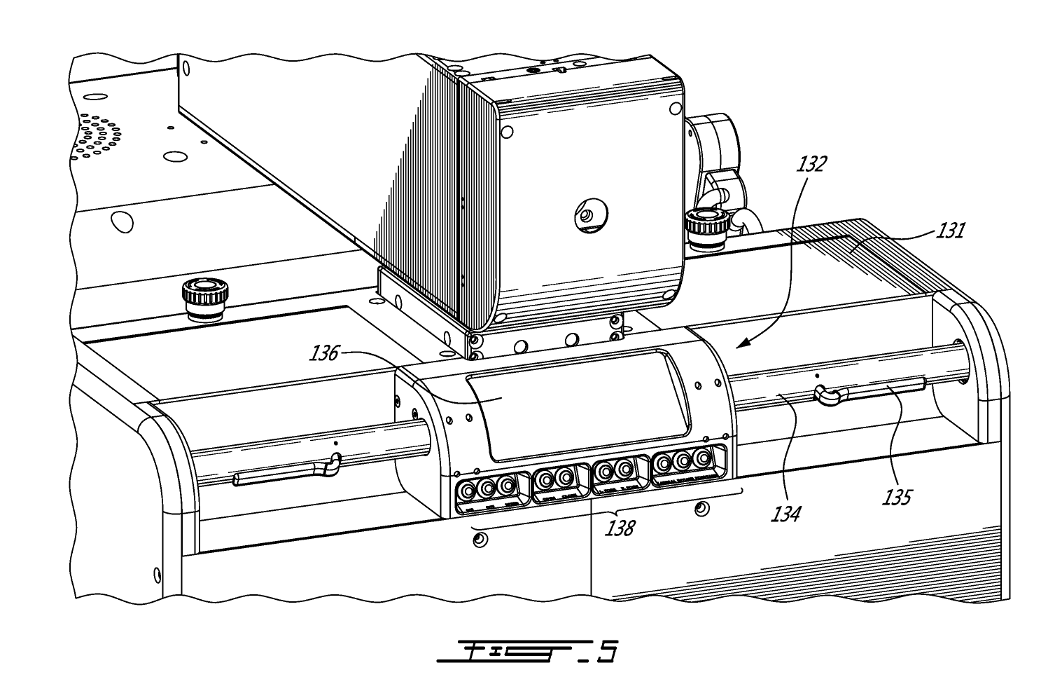

With reference to FIG. 5, the base unit 102 further comprises a control module 132, in this embodiment comprising a pair of drive handles 134 (each fitted with a dead man switch 135 for safety), a graphical user interface 136 (e.g. LED, LCD or touchscreen display) and a series of button actuators 138. For instance, in this embodiment, button actuators include, but are not limited to, on/off/speed buttons (e.g. to power system on or off and select regular vs. low speed modes), open/close buttons (e.g. to splay or narrow base unit feet 130), left fork/right fork buttons (e.g. to selectively splay the right, left and/or both base unit feet 130), and lateral/rotate/forward buttons (e.g. to selectively drive the base unit wheels 131 laterally, to rotate around the system's vertical axis or longitudinally).

In one illustrative example, the control module can be used by an operator of the system 100 to control various features and operations of the device, such as for example, but not limited to, operation of the powered drive module 128, operation of the mast actuator (e.g. raise/lower PPI), operation of the boom actuator (e.g. extend/retract PPI), and/or operation of the PPI (e.g. rotation actuator—clockwise/counter clockwise rotation). For example, in one mode of operation (e.g. a forward drive mode), forward or rearward pressure applied to the drive handles 134 (while activating the dead man switches 135) may communicate a corresponding drive signal to the powered drive module in advancing or backing up the system 100, respectively. Similarly, a differential pressure applied to the handles 134 may result in effective steering of the system 100 (e.g. by advancing one of the drive wheels faster than the other to correspond with a higher pressure applied to the handle corresponding to this faster wheel). Similar operations may be applied in a lateral drive mode, as can rotation of the system 100 when in a rotate drive mode. In another mode of operation (e.g. a positioning mode), upward/downward pressure on the handles 134 may result in a corresponding mast actuation, whereas forward/rearward pressure on the handles 134 may result in a corresponding boom actuation. Opposed forward/rearward pressures on the handles 134 may in this mode result in PPI rotation, for example.

As noted above, dead man switches 135, provided here in the form of levering grip switches, provide for enhanced safety as the system control signals may only be implemented upon each of these switches being adequately actuated, thereby reducing the likelihood of false control orders.

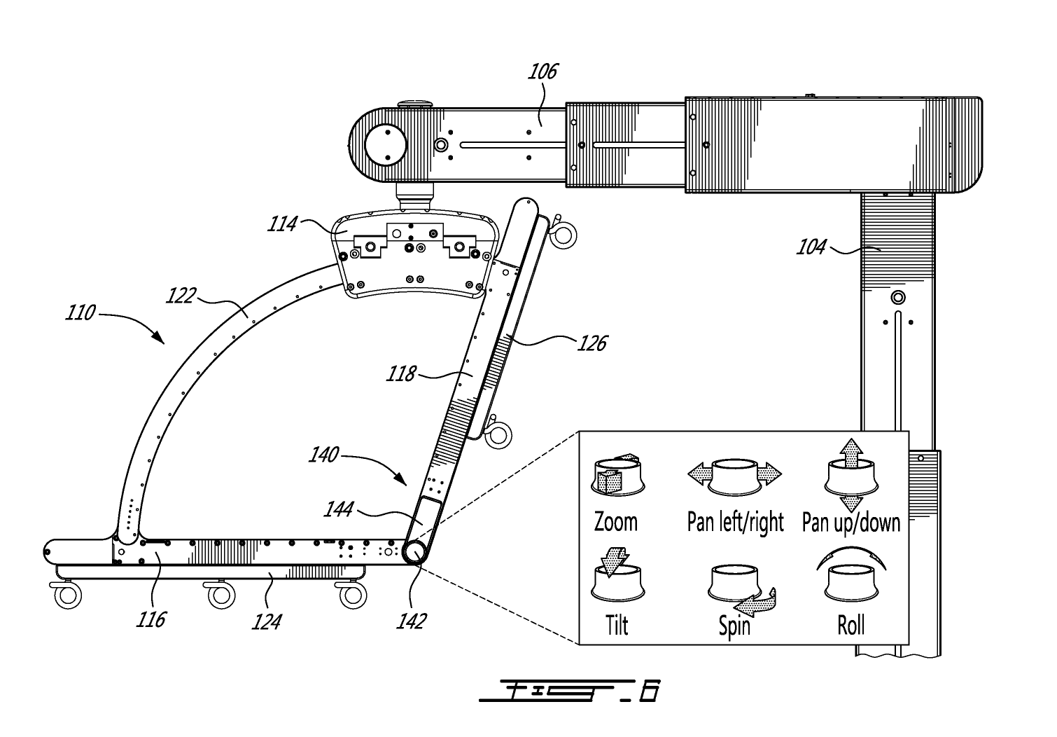

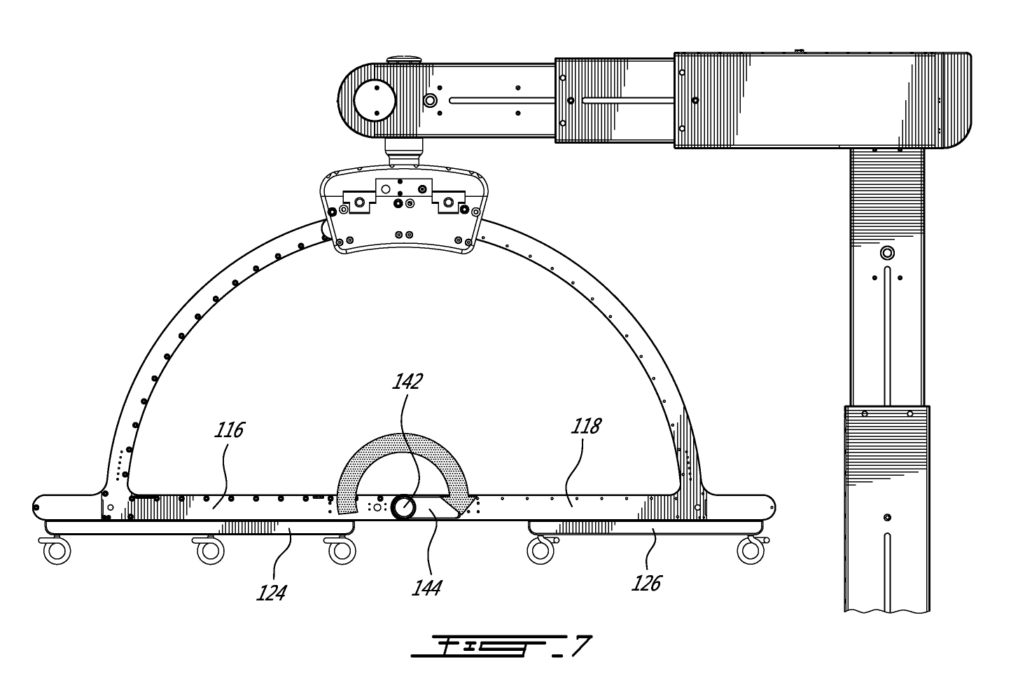

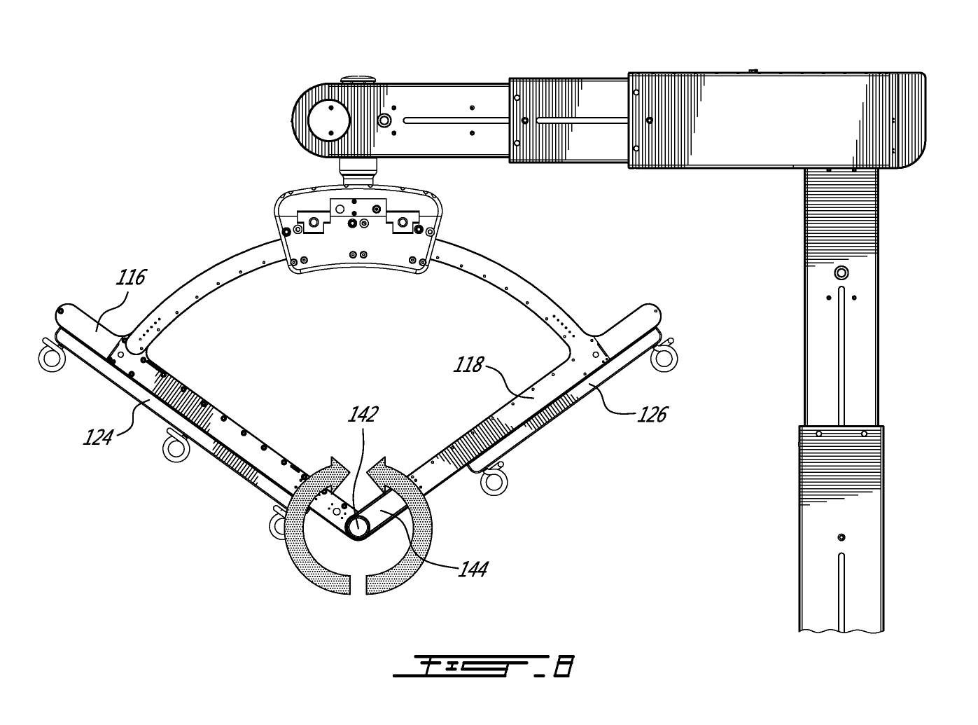

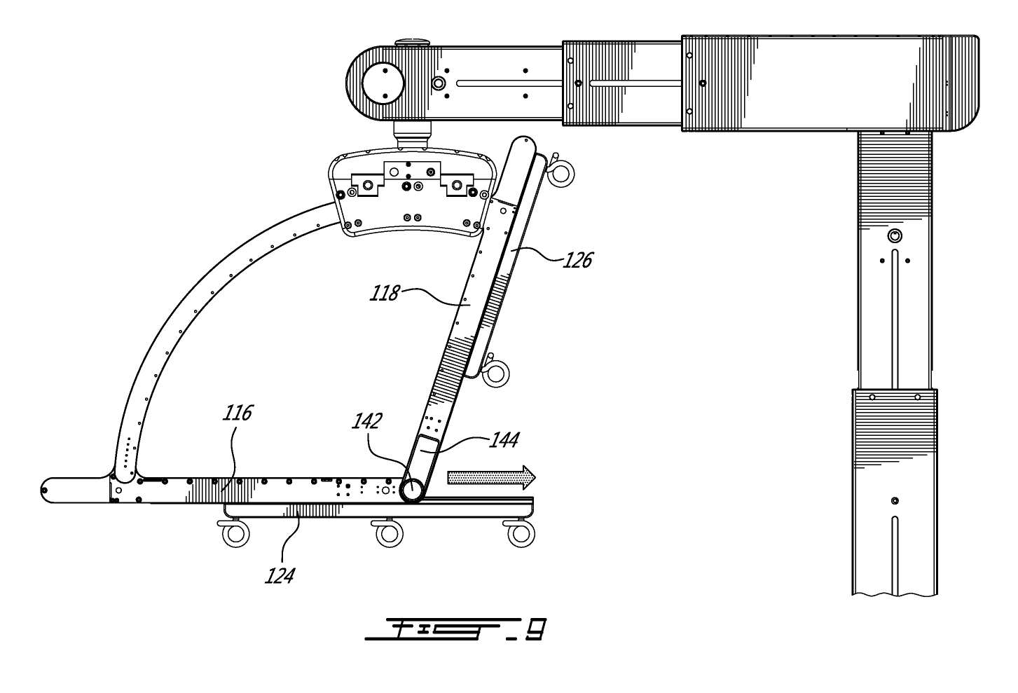

In this particular embodiment, and with reference to FIG. 6, the PPI 110 is further provided with its own integral control device 140, in this embodiment comprising a 3D controller knob 142 and mode selection button 144. For example, the 3D knob 142, in one embodiment consisting of a 3D mouse such as the SpaceNavigator™ for Notebooks manufactured by 3DCONNEXION, is adapted to respond distinctly to both pan/zoom operations (e.g. linear actuations along x, y and z axes) and tilt/spin/roll operations (e.g. rotational actions around each axis) and can thus be configured to actuate up to 6 functions of the PPI in a single mode. By configuring the mode selection button 144, actuation options may be multiplied for each mode. In one example, a first mode translates up/down and forward/backward operations on the control knob 142 to correspondingly actuate the mast 104 and boom 106, respectively, whereas a rotation of the knob 142 results in a corresponding rotation of the PPI actuator hub 114 relative to the boom 106. In a second mode, rotation of the knob 142 may rather angularly deploy and retract the footrest portion 116 (e.g. see FIG. 8), whereas forward/backward actions on the knob 142 may be used to adjust a longitudinal position of the legrest support member 124 (e.g. see FIG. 9). Similarly, a backrest mode may be used to angularly deploy and retract the backrest portion 118 (see FIGS. 7, 8) and slidingly actuate the backrest support member 126. It will be appreciated that while the above provides some examples of an illustrative suite of intuitive control functions available through the combined 3D controller knob 142 and mode selection button 144, other control combinations in different mode selections may also be considered without departing from the general scope and nature of the present disclosure. For example, different controls may be configured to maximize operations within a single mode, or again combined to automatically reposition the PPI between preset patient configurations (e.g. lie-flat to lift, lift to seated, seated to reclined, etc.). Similarly, while a particular PPI control actuator is provided in this example for the purpose of controlling the PPI in direct proximity thereto, other types of control actuators, such as provided integrally with the base unit control module 132, provided via a wired or wireless remote controller, etc., may also or alternatively be considered without departing from the general scope and nature of the present disclosure. In any event, the embodiments considered herein provide an intuitive control device, and associated platform, to control and drive actuation of the PPI and/or base unit via a tactile user interface that is responsive to both linear and rotational user actions, be they physically implemented on a moveable user interface (e.g. such as via the 3D knob discussed above), and/or via other user interfaces such as a touch-sensitive interface allowing for the touch-operable actuation of the system (e.g. via linear and/or rotational touch operations implemented on the touch-sensitive interface).

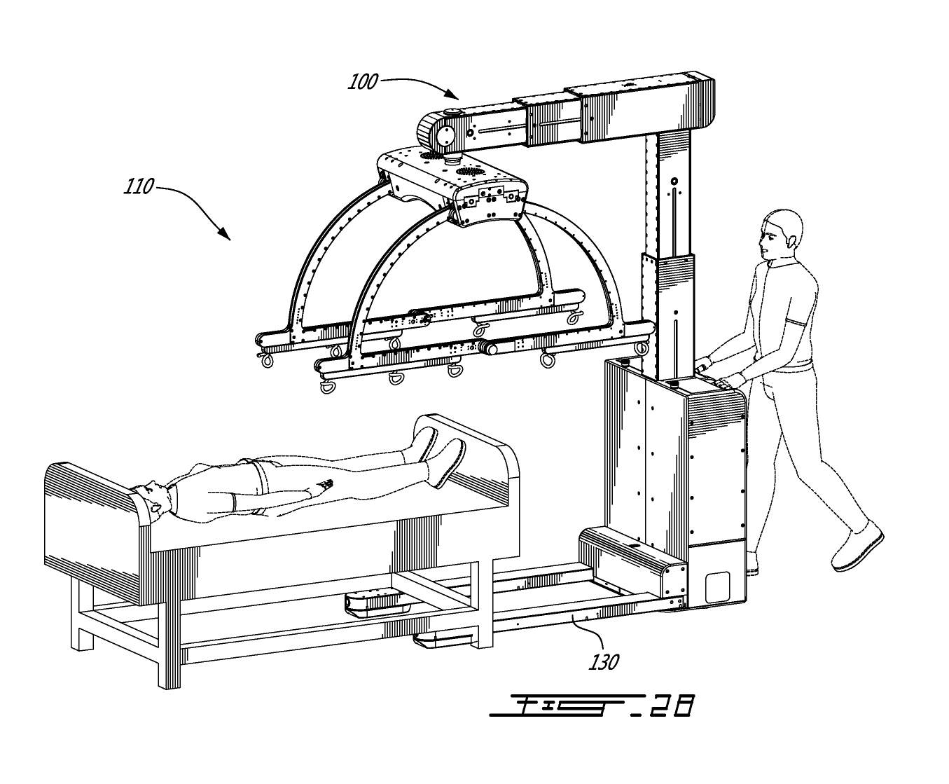

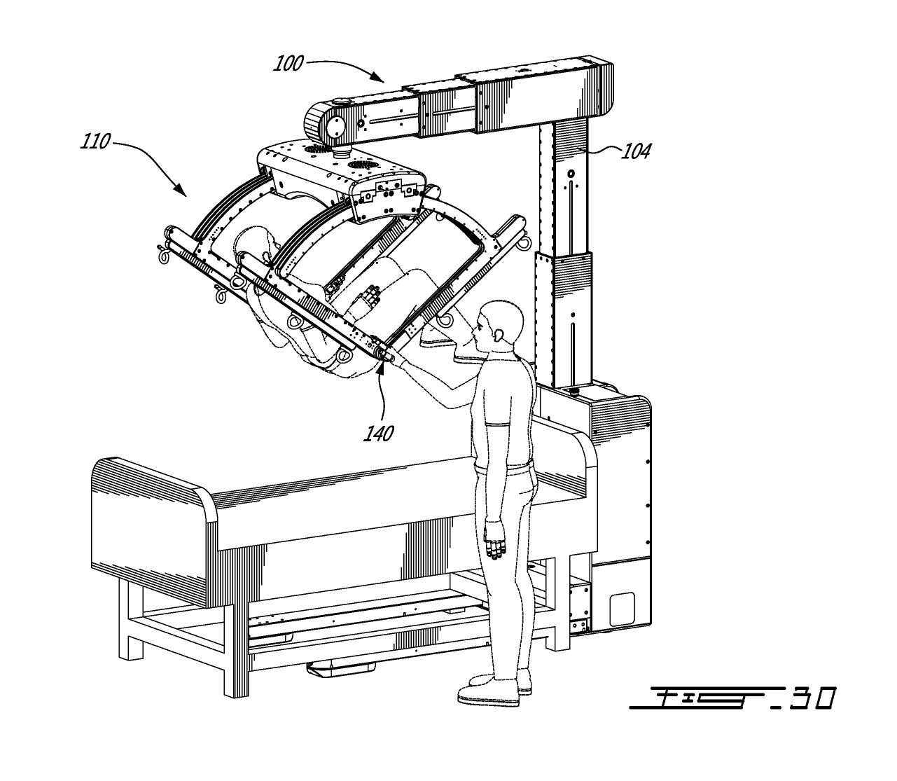

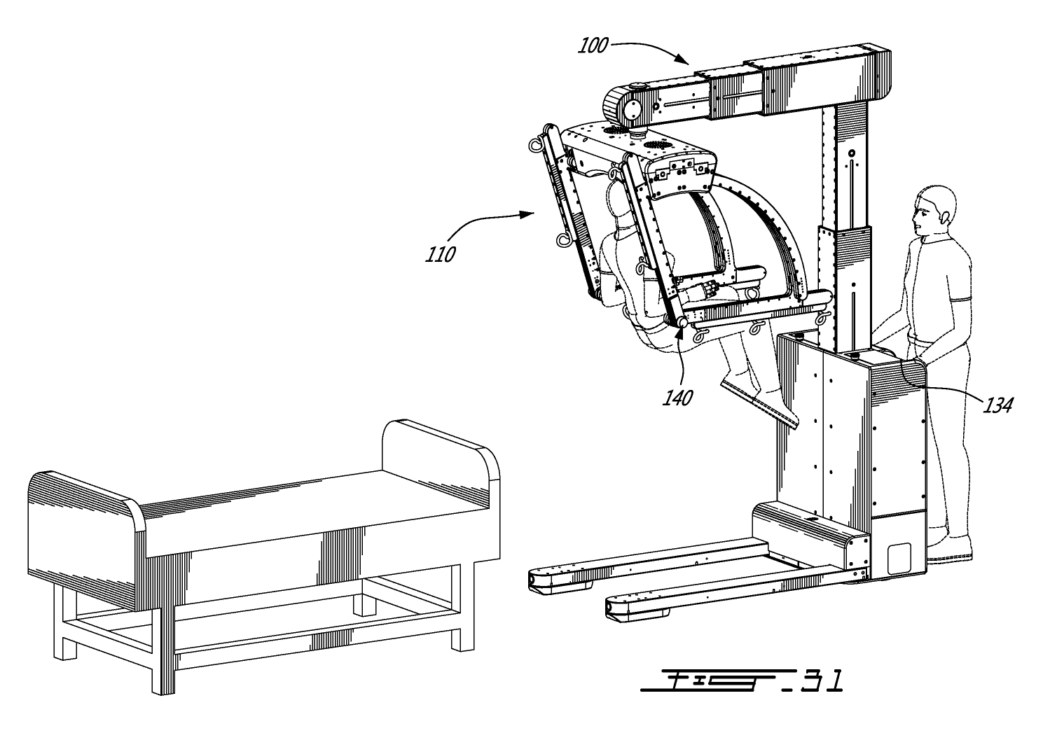

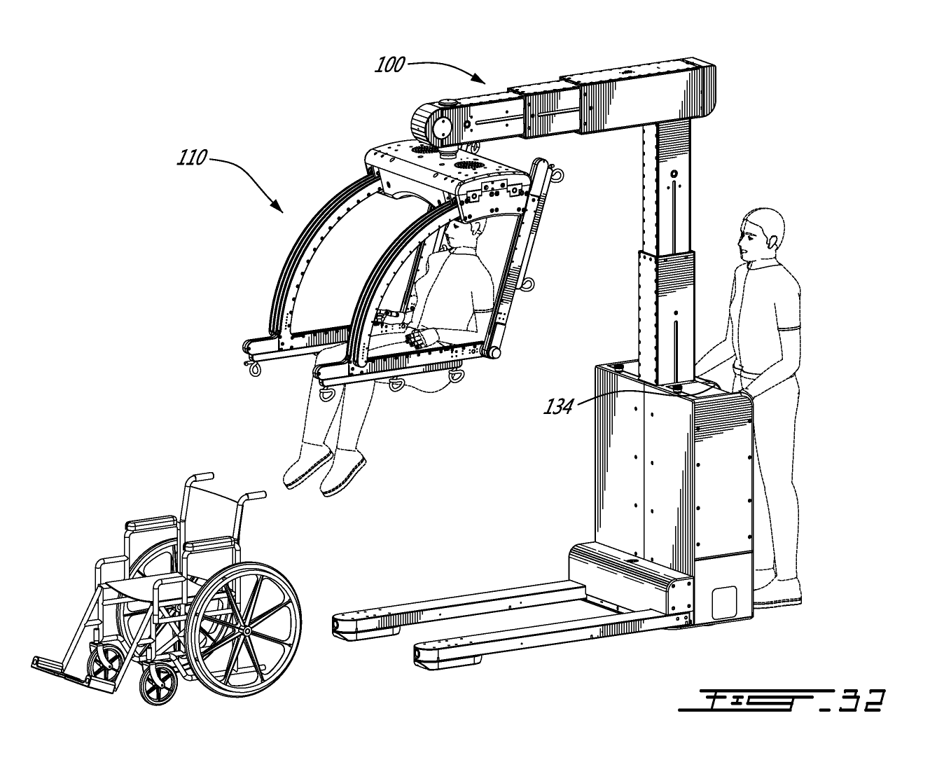

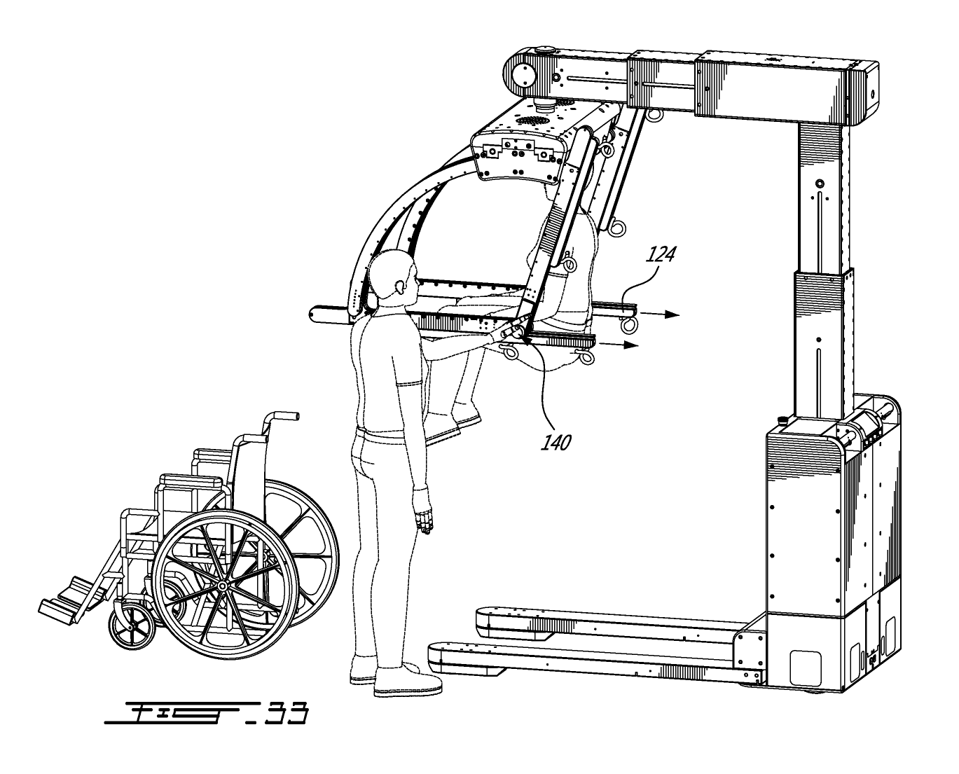

With reference to FIGS. 28 to 35, the system 100 is shown in an exemplary sequence, whereby the system 100 is first brought toward a patient lying in bed (FIG. 28), with the feet 130 conveniently sliding underneath the bed as the PPI 110 approaches the patient. In FIG. 29, the PPI 110 is lowered by actuation of the mast 104 via drive handles 134 of base unit control module 132 (or alternatively via the PPI control device 140), where one or more lift/support straps, slings and/or harnesses (not shown) disposed underneath the patient can be operatively coupled to the legrest and backrest support members 124, 126. In FIG. 30, the system operator operates the PPI 110 via PPI control device 140 to lift the patient via actuation of the mast 104, and reposition the patient from a lying to transport position. The system operator reorients the patient into a seated (slouched) position via PPI controller 140, before returning to the base unit drive handles 134 to back up the system 100 away from the bed (FIG. 31). The drive handles 134 are also used to rotate the PPI and patient being transported thereby, and transport the patient to a wheelchair (FIG. 32). In FIG. 33, the operator is seen using the PPI control device 140 to adjust the patient position from a seated-slouched position to a seated-aligned position via lengthwise actuation (i.e. depicted by longitudinal rearward arrows) of the legrest support member 124. The operator returns to the drive handles 134 to position the patient above the wheelchair while automatically splaying the base unit's feet 130 (FIG. 34), and ultimately lower the patient into the wheelchair upon actuation of the mast 104 (FIG. 35), at which point the lift/support strap(s), harness(es), sling(s) or the like may be removed.

It will be appreciated that the above provides only one illustrative operation sequence of the system 100, and that multiple other sequences may be considered within the present context to take advantage of the various functional and operational features of the system 100.

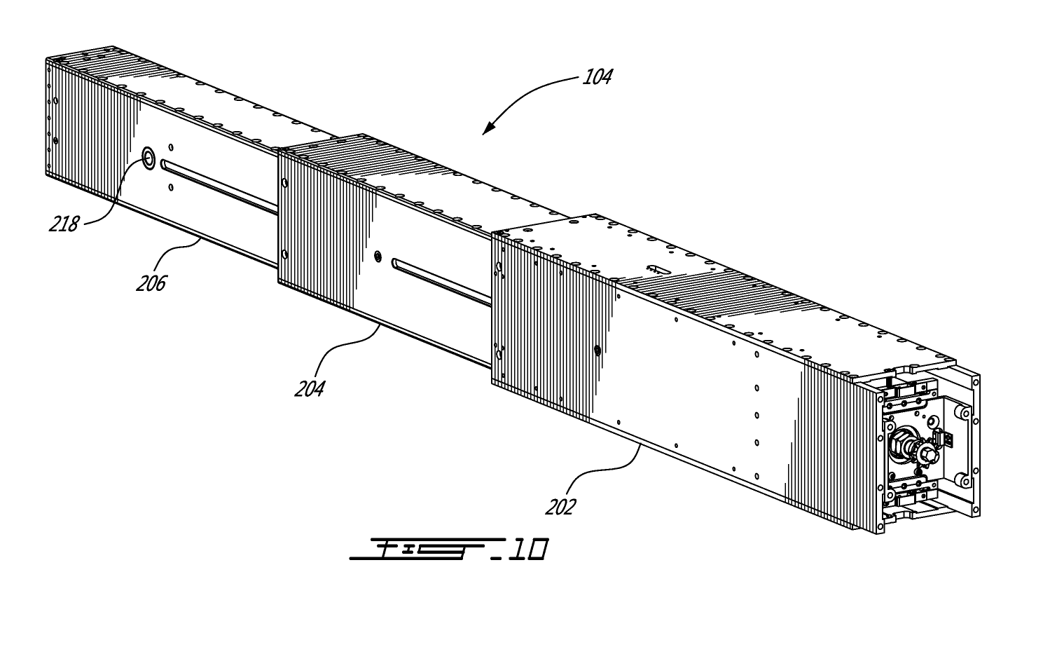

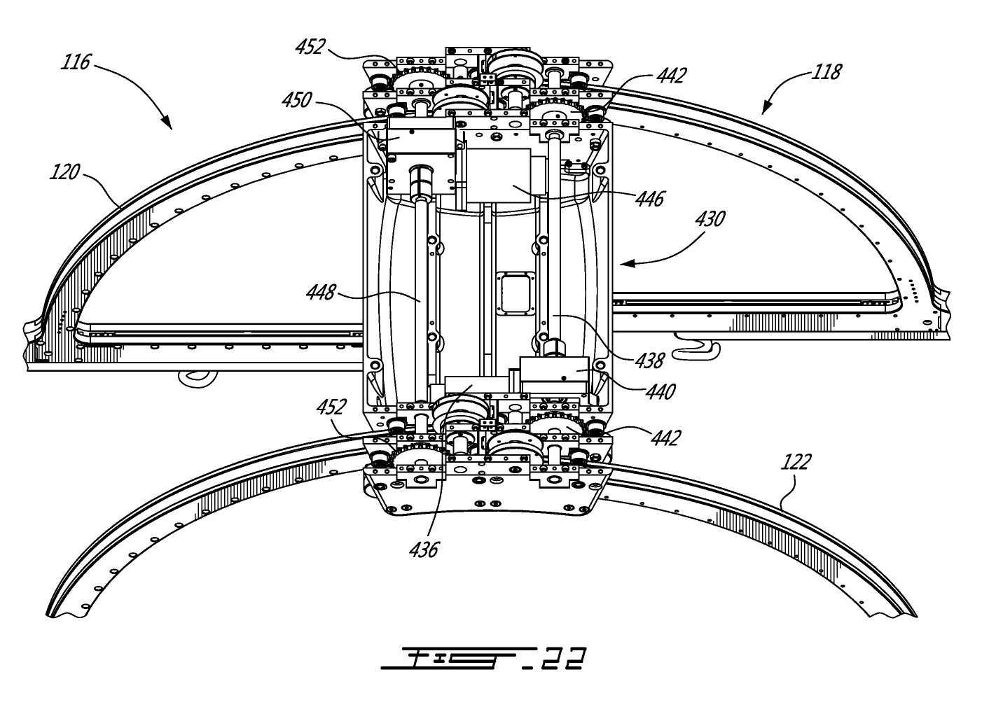

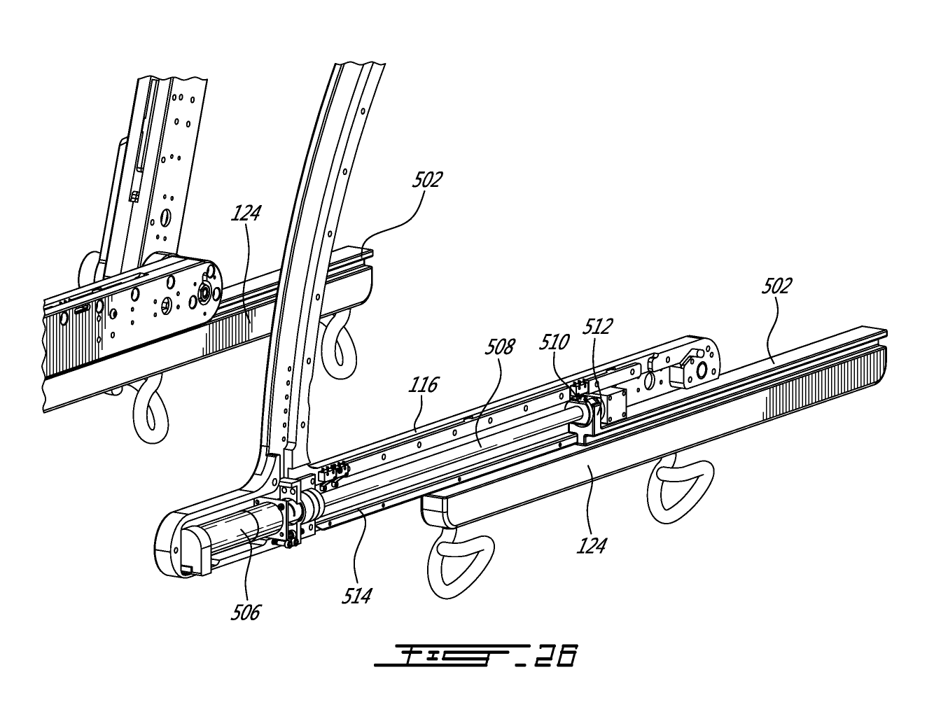

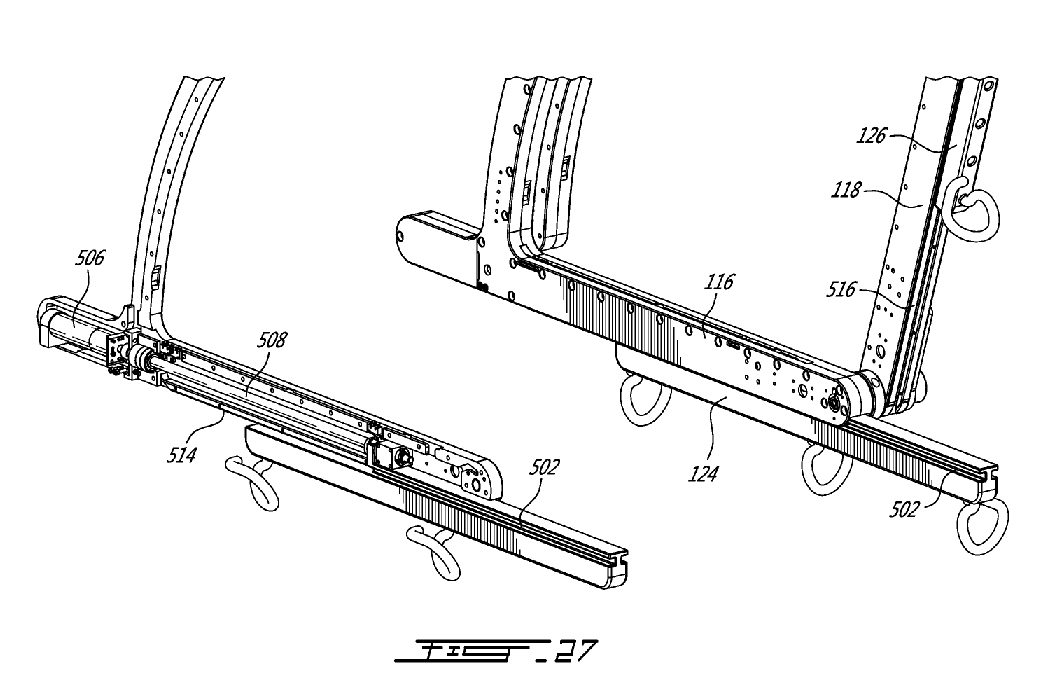

Reference will now be made to FIGS. 10 to 27 in showing a detailed construction of the patient lift system 100 of FIG. 1, in accordance with an exemplary embodiment of the invention.

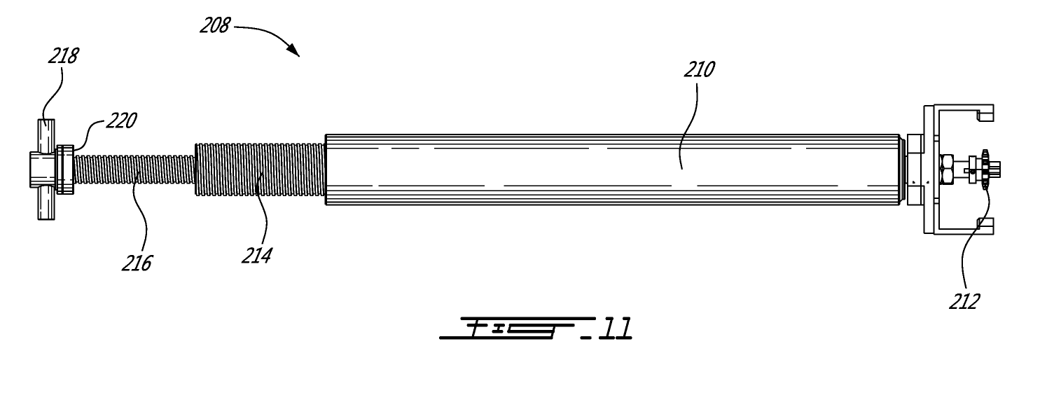

With particular reference to FIGS. 10 and 11, the mast 104 generally comprises base 202, middle 204, and inner 206 box sections (FIG. 10) adapted to slidingly engage one another in providing for telescoping extension and retraction of the mast 104 upon actuation of a corresponding set of concentric lead screws 208 (FIG. 11) operatively disposed therein. Base box section 202 is secured to the system base unit 102 (FIG. 1) to stand vertically therefrom and allow for the middle and inner box sections 204, 206 to contract therein and extend therefrom in operation. Similarly, an outer cylindrical lead screw 210 is drivably secured to the base unit 102 via a driveable sprocket 212 and drive chain (not shown). Middle 214 and inner 216 lead screws are adapted to retract within and extend from the outer lead screw 210 upon the latter being driven by the drive chain. A pin 218 provided at a distal end 220 of the inner screw 216 is secured to the inner box 206 thus driving the mast 104 to extend and retract as the inner lead screw 216 is extended and retracted.

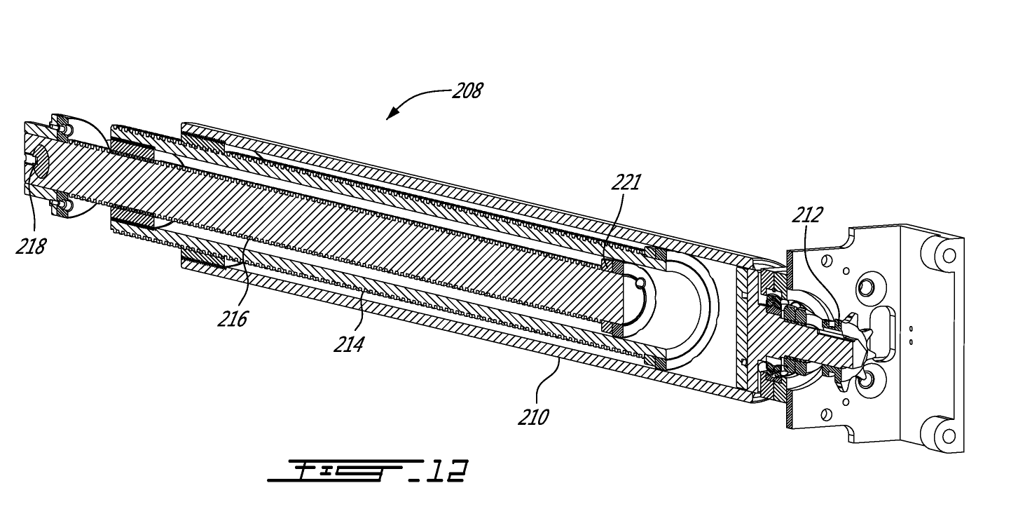

FIG. 12 provides a perspective cross-sectional view of the lead screws 208 in a fully retracted position.

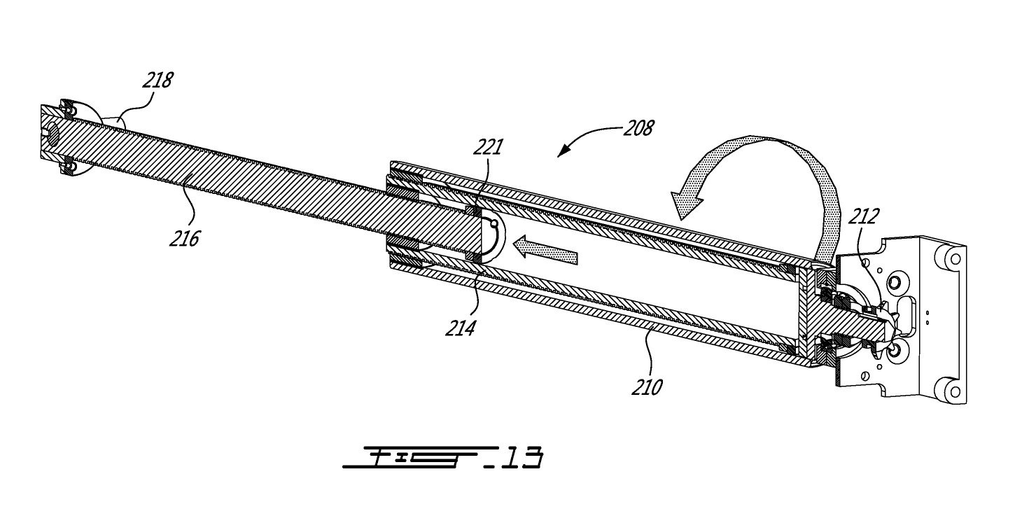

With added reference to FIG. 13, as the outer screw 210 revolves upon being driven by the sprocket 212 and chain connection, it transfers rotary motion through the co-revolving middle lead screw 214 to the non-revolving inner screw 216, thus extending or retracting the inner screw, and consequently the inner mast section 206 fixedly coupled thereto via pin 218. Plastic bumpers 221 are also provided to cushion the impact of rotating outer and middle leads and non-rotating, but traveling, inner lead screw 216. It will be appreciated that while the inner lead screw 216 is shown to extend first in this illustrative embodiment, different mechanical parameters may rather induce the middle screw 214 to extend first, or rather, have both the inner and middle screws 214, 216 extend or retract simultaneously and/or intermittently.

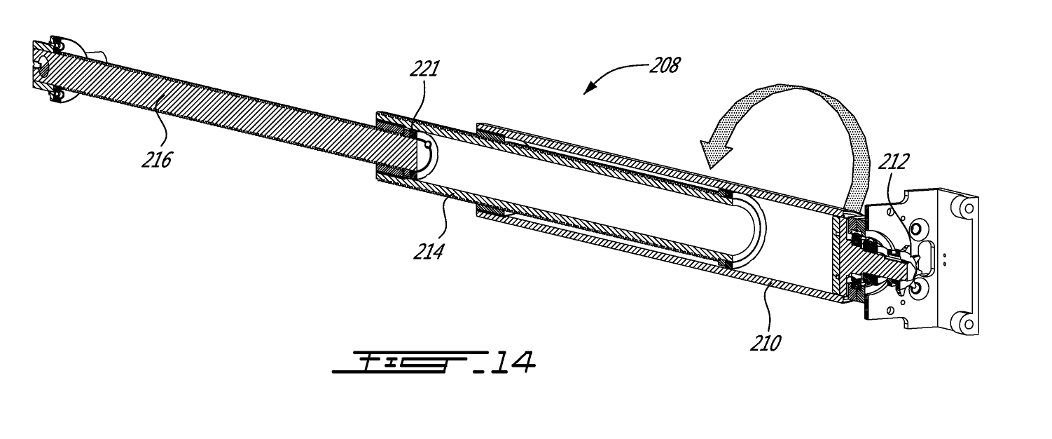

With reference to FIG. 14, once the inner lead 216 has travelled to its full extent, it locks with the middle lead 214, inhibiting further rotation to the middle lead screw and again converting rotary motion of the outer lead screw 212 to linear travel.

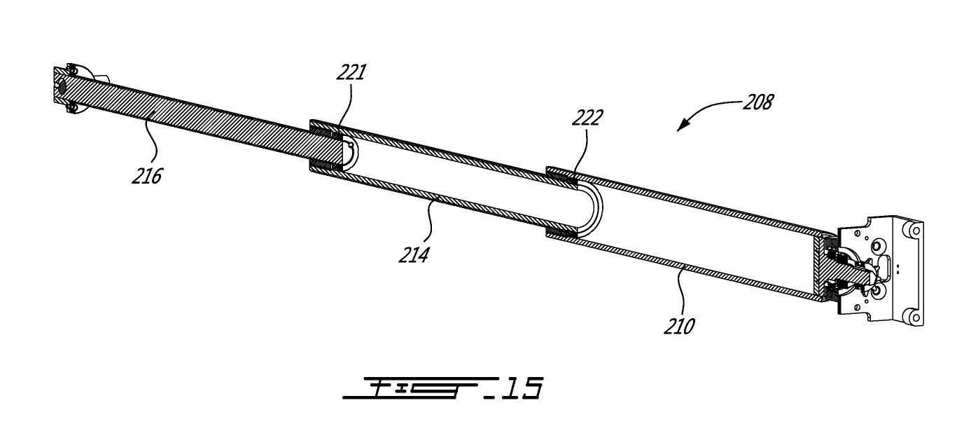

With reference to FIG. 15, the middle and outer lead screws 214, 212 bottom out with a similar plastic bumper 222 as that provided for the inner screw 216. External failsafes are also provided to stop a complete bottoming out of the mast 104.

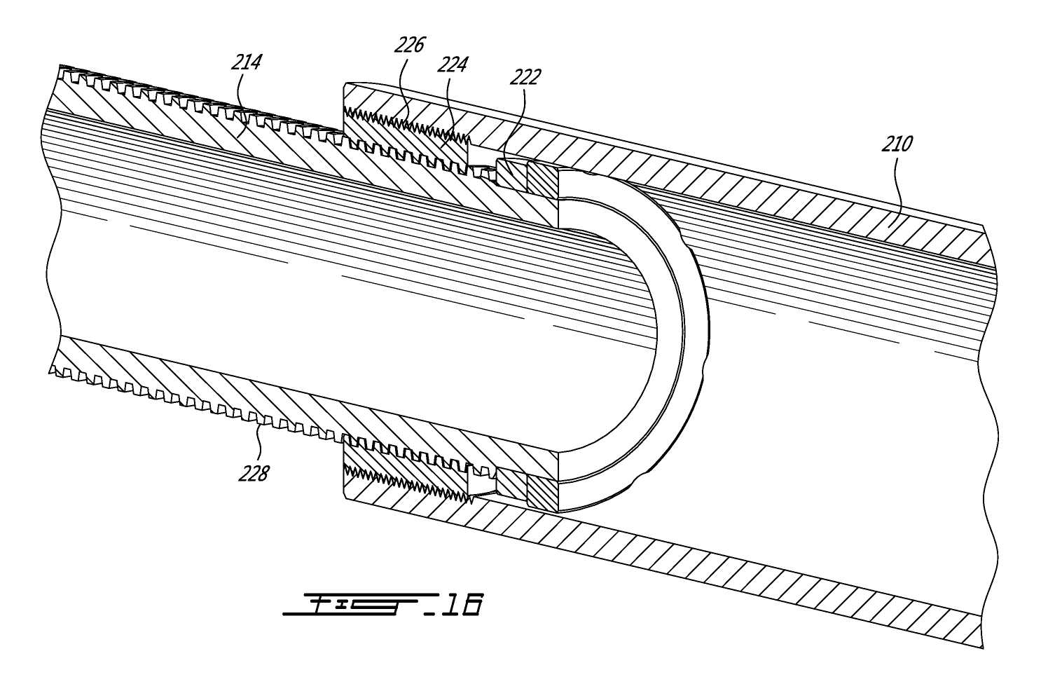

FIG. 16 provides a close-up of the lead screw interface between outer 210 and middle 214 lead sections. In this example, a bearing bronze 224 is secured to the outer lead 210 via fine threads 226, whereas acme screw threads 228 guide telescoping action of the middle screw 214 upon relative rotation of the outer lead 210. Bumper 222 can also be seen in this Figure, to abut against bearing bronze 224 upon the middle lead 214 reaching a maximum axial travel.

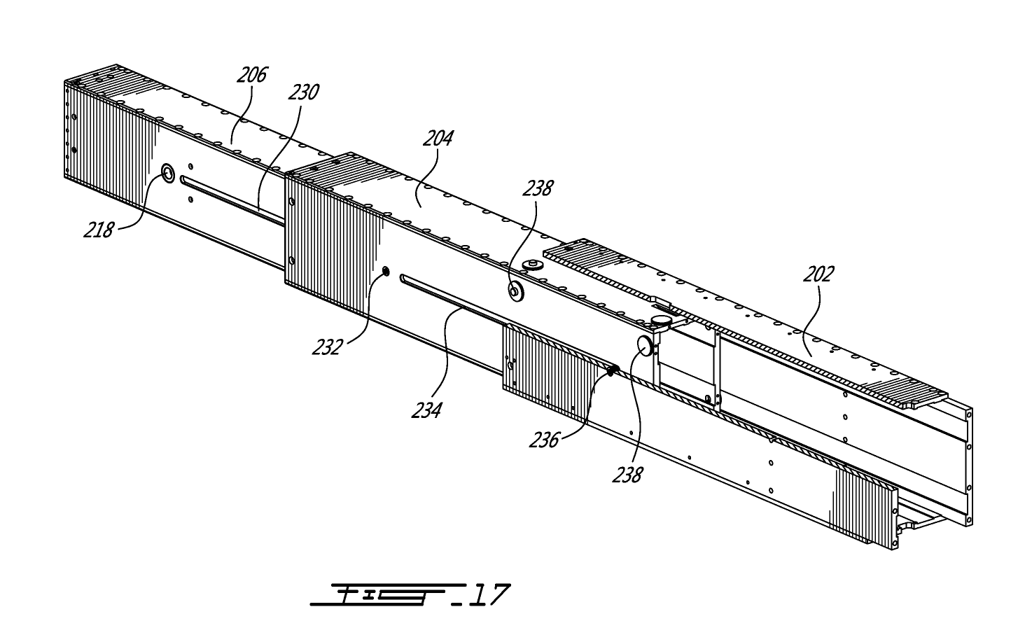

FIG. 17 illustrates the sliding engagement of the telescoping mast sections. In particular, and as noted above, the inner box section 206 is pinned to the inner lead screw via pin 218. The middle box section 204 floats between inner and outer boxes 206, 202 by way of inner box slot 230 and retaining pin 232, and middle box slot 234 and retaining pin 236. The outer box section 202 is stationary and bolted to the base of the system. Bearing/wear plates 238 are also provided to facilitate the relative sliding action of the boxes.

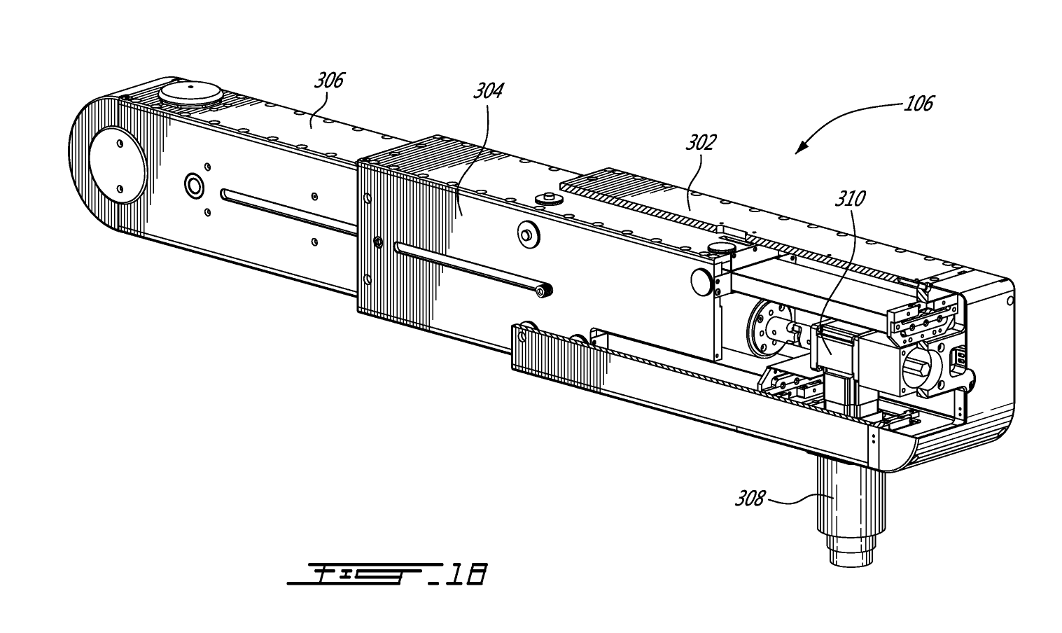

With reference to FIG. 18, the boom 106 is generally constructed like the mast 102, in that three telescoping box portions 302, 304 and 306 are slidingly engaged within one another and driven by a corresponding set of concentric lead screws (not shown). Rather than to be driven by a sprocket and drive chain, however, the extension and retraction of the boom 106 is rather actuated by lead screw motor 308 and right-angled gear box 310.

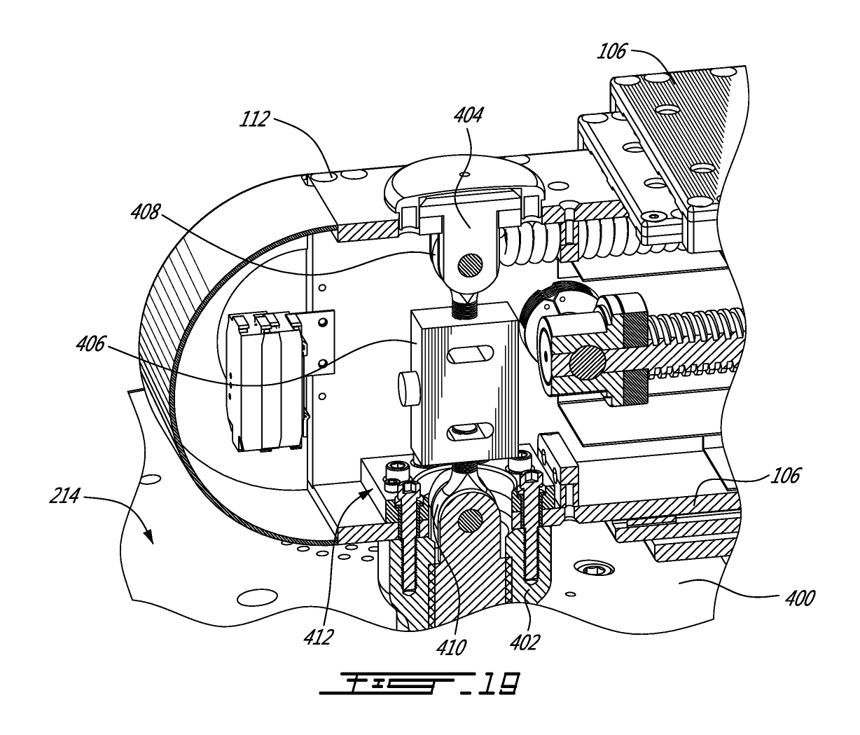

With reference to FIGS. 19 to 21, an upper portion 400 of the PPI actuator hub 214 is rotationally coupled to the free hanging extremity 112 of the boom 106 via stationary neck portion 402. In this embodiment, neck portion 402 is secured to the boom 106 via a coupler 404 fitted through an aperture in the top panel of the boom and having a capped head that rests securely upon this top panel. A load sensor 406 is interposed between opposed spherical rods 408, 410 respectively interconnecting the neck portion 402 to the coupler 404 and thus allowing for a weight of a patient to be measured during transport. In this embodiment, the load sensor 406 is isolated to z-axis measurements via an isolation bolt circle 412, which allows for a fraction of an inch of vertical travel to properly weigh patients, while doubling as a safety mechanism should one of the load sensor couplings fail.

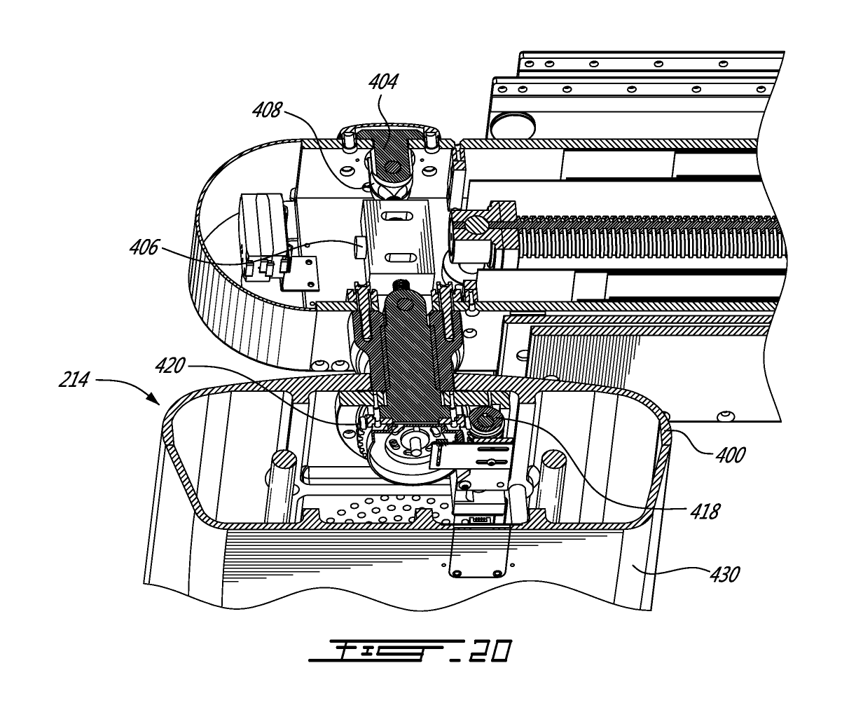

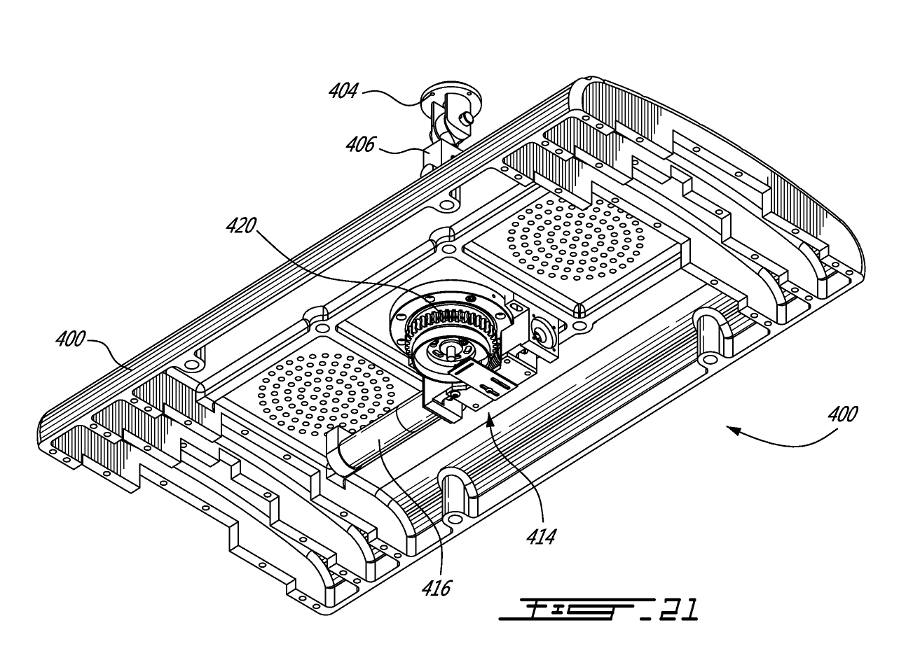

As best seen in FIGS. 20 and 21, the neck portion 402 is stationary, with the actuator hub 214 walking around its neck 402 with continuous 360 degree freedom by way of a worm drive 414 (e.g. drive motor 416, worm 418 and worm gear 420). In this particular configuration, the worm gear 420 is stationary and the body 400, motor 416 and worm 418 walk around the gear 420.

With reference to FIGS. 20, 22 to 24, a lower portion 430 of the PPI actuator hub 214 is adapted to be secured to the upper portion 400 and house therein respective drive mechanisms for the arcuate rails 120, 122 of legrest portion 116 and backrest portion 118, respectively. In particular, the legrest drive mechanism comprises a motor 436 that turns a common shaft 438 via a worm drive gearbox 440, the shaft 438 connected at each end to respective sprockets 442 configured to drive the set of arcuate rails 120. Similarly, the backrest drive mechanism also comprises a motor 446 that turns a common shaft 448 via a worm drive gearbox 450, the shaft 448 connected at each end to respective sprockets 452 configured to drive the set of arcuate rails 122. Accordingly, each set of arcuate rails 120, 122 can be driven independently, while permitting for both rails of a given set to be moved and positioned simultaneously.

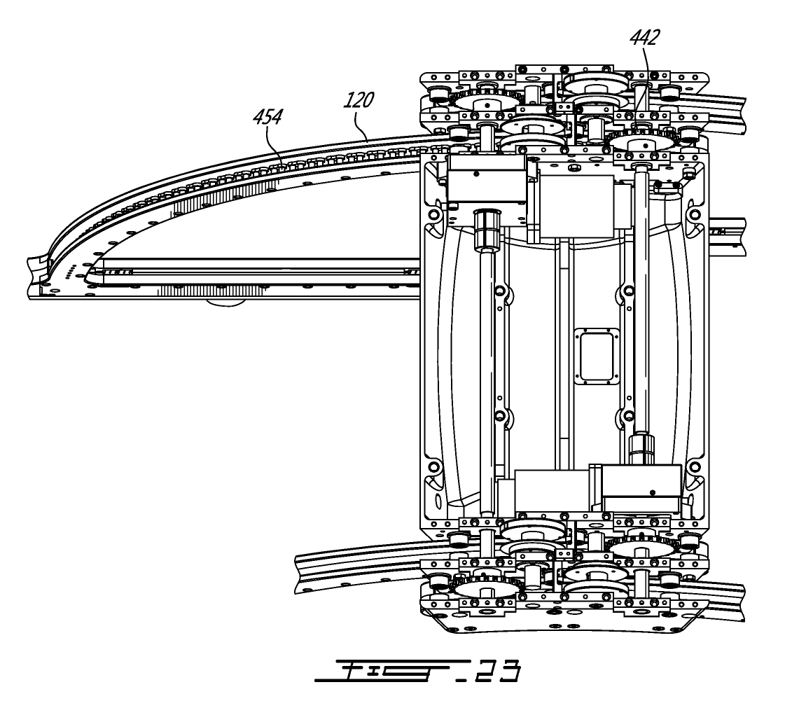

With particular reference to FIG. 23, a drive chain 454 is secured within each rail portion (e.g. as in rail 120) so to be engaged and driven by a corresponding sprocket (e.g. as in sprocket 442). Other drive means such as a corresponding pinion or circular gear may also be considered to provide a like effect, as will be appreciated by the skilled artisan.

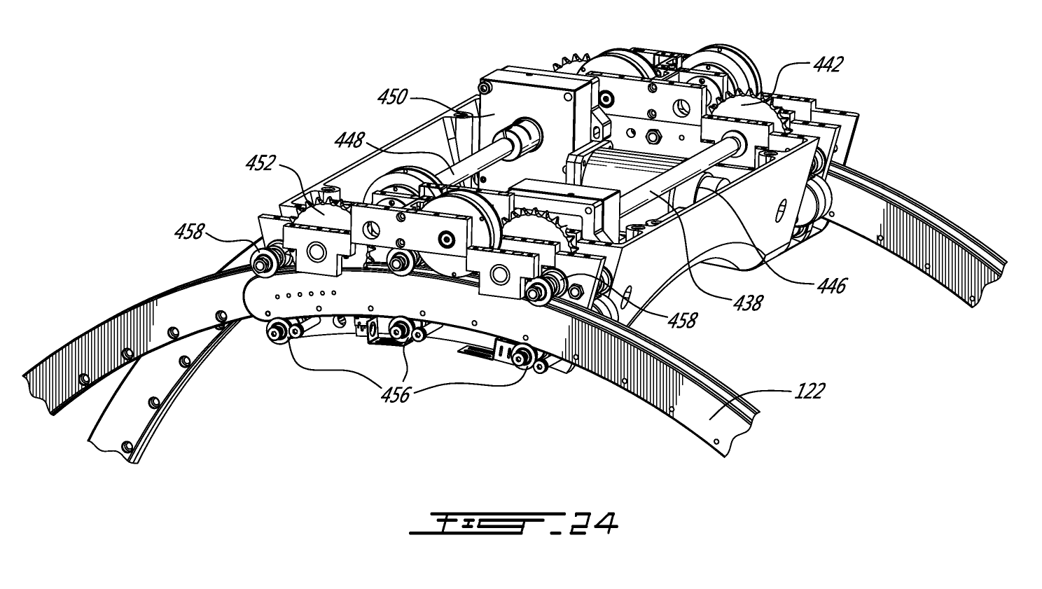

With particular reference to FIG. 24, the arcuate rails (e.g. as in rails 122) are restrained to rotate around a common centre point defined in this embodiment by the pivoting interconnection of legrest 116 and backrest 118 portions (e.g. see FIG. 1), which further corresponds with the location of the PPI control device 140. Namely, bottom drum rollers 456 hold the rails and top cam followers 458 lower down on top of the rails for a tight fit.

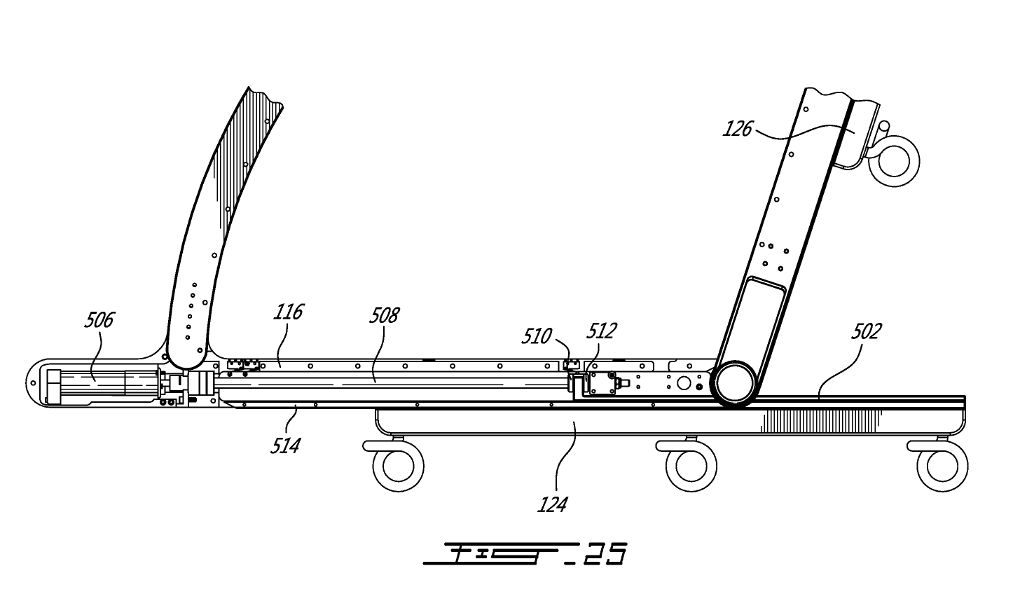

With reference to FIGS. 25 to 27, a mechanism for imparting a lengthwise adjustment of the legrest support member 124 will now be described in greater detail. In this embodiment, each support member 124 consists of a slider carriage having an upper I-shaped rail 502 that is slidingly engaged within a correspondingly shaped channel formed with a base of the legrest portion 116. A motor 506, secured lengthwise within the base of legrest portion 116, operates on a lead screw 508 itself extending lengthwise along the base of legrest portion 116. The lead screw 508 is configured to engage and drive a bronze nut 510 along its length, which bronze nut 510 also serves as a coupler to a correspondingly shaped and sized two-pronged fork 512 formed within the rail 502, thus ultimately acting to draw and push the support member 124 forward and backward, respectively, upon action of the motor 506 on the lead screw 508. Use of the bronze nut 510 not only provides for effective coupling of the lead screw 508 and rail 502, but also allows mitigation of out-of-axis misalignment issues that may arise from unaccounted forces.

As will be appreciated by the skilled artisan, while the slider carriages of respective legrest support members 124 are not mechanically linked to have imparted thereto simultaneous lengthwise adjustments from a common drive, a processor for the control module may be configured to process a user action on the PPI control device 140 and command both related legrest support members 124 to move in concert.

As partially shown in these figures, a similar mechanism is provided for providing operative sliding engagement of the backrest support member 126 within a base of backrest portion 118.

In accordance with one embodiment, the rail 502 (and corresponding rail of backrest support member 126) rides on a low CoF bearing surface 514 (516) manufactured of, for example, but not limited to, ultra-high-molecular-weight polyethylene (UHMW PE).

While the present disclosure describes various exemplary embodiments, the disclosure is not so limited. To the contrary, the disclosure is intended to cover various modifications and equivalent arrangements included within the general spirit and scope of the present disclosure.

1. A patient positioning interface to be suspended from a patient support mechanism and used in positioning a thus supported patient in two or more positions, the interface comprising:
a legrest portion for supporting a lower body portion of the patient;
a backrest portion pivotally coupled to said legrest portion for supporting an upper body portion of the patient;
a powered drive mechanism independently acting on each of said legrest portion and said backrest portion to independently adjust relative to one another a legrest and backrest angle of said legrest portion and backrest portion, respectively.

2. The interface of claim 1, wherein each of said legrest and backrest portions are continuously adjustable over a range of angular positions.

3. The interface of claim 1, wherein each of said legrest portion and said backrest portion comprise a respective support member defining a patient-support alignment respective thereto, each said respective support member directly or indirectly pivotally coupled to one another via a pivot in providing a relative angular alignment of said legrest portion and backrest portion about said pivot.

4. The interface of claim 3, each said support member operatively driven by said power drive mechanism via an arcuate rail operatively interconnecting said power drive mechanism to a point on said support member longitudinally distanced from said pivot, wherein said arcuate rail defines an arcuate path along which said rail is driven to deploy and retract said support member around said pivot to thereby adjust said relative angular alignment.

5. The interface of claim 1, further comprising a rotational drive mechanism integral thereto, wherein the interface is suspended from the patient support mechanism via said rotational drive mechanism, said rotational drive mechanism thus operable to rotate the interface about a substantially vertical axis.

6. The interface of claim 5, wherein at least one said support member is a lengthwise adjustable support member to adjust a lengthwise position thereof relative to said pivot and thereby serve to adjust a posture of the patient supported thereby.

7. The interface of claim 5, wherein each said support member is an independently lengthwise adjustable support member to adjust a respective lengthwise position thereof relative to said pivot and thereby serve to adjust a posture of the patient supported thereby.

8. The interface of claim 3, further comprising a control device integral thereto for directly actuating adjustment of said relative angular alignment.

9. The interface of claim 8, wherein said control device is operatively connected to a patient support mechanism controller to remotely control at least one of a support mechanism height adjustment drive, a support mechanism length adjustment drive, and a support mechanism rotation drive.

10. The interface of claim 6, further comprising a control device integral thereto, wherein said control device receives as input at least one linear operation to impart a corresponding linear actuation of said at least one length adjustable support member, and at least one rotational operation to impart a corresponding rotational actuation of a corresponding one of said legrest portion and said backrest portion.

11. The interface of claim 10, wherein said control device further comprises a mode selector to select between at a legrest actuation mode and a headrest actuation mode to selectively actuate one of said headrest portion and said legrest portion via said at least one linear operation and said at least one rotational operation.

12. A patient lift and positioning system comprising:
a mobile patient support unit comprising:
a base unit;
a height adjustable mast extending upwardly from said base unit; and
a length adjustable boom extending outwardly from an upper section of said mast; and
a patient positioning interface operatively suspended from said boom thereby allowing for vertical and horizontal adjustment thereof relative to said base unit, said interface comprising:
a legrest portion for supporting a lower body portion of the patient;
a backrest portion pivotally coupled to said legrest portion for supporting an upper body portion of the patient; and
a powered drive mechanism independently acting on each of said legrest portion and said backrest portion to independently adjust relative to one another a legrest and backrest angle of said legrest portion and backrest portion, respectively, to position the patient in two or more positions.

13. The patient lift and positioning system of claim 12, said mobile base unit comprising a powered-drive module.

14. The patient lift and positioning system of claim 13, said interface rotationally coupled to said boom via a powered rotational drive mechanism to provide powered rotation of the patient thus supported.

15. The patient lift and positioning system of claim 12, wherein said interface further comprises a control device integral thereto and operatively coupled to said powered drive mechanism to directly control adjustment of said legrest portion and said backrest portion, wherein said control device is further operatively coupled to said base unit to remotely control adjustment of at least one of said mast and said boom.

16. The patient lift and positioning system of claim 15, wherein said control device further comprises a mode selector to select between at a direct interface control mode and a remote support unit control mode.

17. A patient lift and positioning system comprising:
a mobile patient support unit; and
a patient positioning interface suspended from said patient support unit, said patient positioning interface comprising:
a legrest portion for supporting a lower body portion of the patient;
a backrest portion pivotally coupled to said legrest portion for supporting an upper body portion of the patient; and
a powered drive mechanism independently acting on each of said legrest portion and said backrest portion to adjust a relative angular positioning therebetween and thus allow positioning of the patient in a seated position;
wherein at least one of said backrest portion and said legrest portion comprises a powered lengthwise adjustable support member by which the patient is at least partially supported; and
wherein lengthwise adjustment of said powered adjustable support member serves to adjust patient posture in said seated position.

18. The system of claim 17, wherein each of said backrest portion and said legrest portion comprises a respective powered lengthwise adjustable support member.

19. The system of claim 17, wherein patient posture is adjusted from a seated slouched position to a straight-seated position via said lengthwise adjustment.

20. The system of claim 17, wherein the mobile patient support unit is configured to lift, carry and lower the patient in a chair, and wherein the patient positioning interface is configured to position the patient in a first position while being carried, and configured to reposition the patient, prior to being lowered, in an upright seated position corresponding to the chair via actuation of at least said one or more lengthwise adjustable support members.
